(19) United States
(12) Patent Application Publication
(10) Pub. No.: US 2026/0043509 A1
(43) Pub. Date: Feb. 12, 2026

(54) REUSABLE CLAMP

(71) Applicant: Nordson Corporation, Westlake, OH (US)

(72) Inventors: Jack Wise, Erie, CO (US); Peter Lewis, Loveland, CO (US); Francis J. Lombardi, III, Longmont, CO (US)

(21) Appl. No.: 19/124,486

(22) PCT Filed: Oct. 26, 2023
(86) PCT No.: PCT/US2023/077819

§ 371 Date: Apr. 25, 2025

Related U.S. Application Data
(60) Provisional application No. 63/380,992, filed on Oct. 26, 2022.
(60) Provisional application No. 63/494,098, filed on Apr. 4, 2023.

(51) Int. Cl. F16L 47/14

(52) U.S. Cl. CPC F16L 47/14; F16L 2201/44

(57) ABSTRACT

A clamp (5) includes first and second gland members (10, 20) having first and second joint portions (11, 21), first and second locking portions (12, 22), and first and second clamping portions (13, 23) disposed between the joint portions and the locking portions. The first and second joint portions are connected for movement of the first and second gland members between an open position and at least one clamping position. The first locking portion is configured to interlock with the second locking portion to secure the first and second gland members in the at least one clamping position. The first and second locking portions further include corresponding first and second user manipulable release portions (15, 25), independently operable for disengagement of the corresponding one of the first and second locking portions from the other of the first and second locking portions to permit movement of the first and second gland members to the open position.

### CROSS-REFERENCE TO RELATED APPLICATIONS

This application claims priority to and all benefit of U.S. Provisional Patent Application Ser. No. 63/380,992, filed on Oct. 26, 2022 and entitled REUSABLE CLAMP, and U.S. Provisional Patent Application Ser. No. 63/494,098, filed on Apr. 4, 2023 and entitled REUSABLE CLAMP, the entire disclosures of each of which are incorporated by reference herein.

### TECHNICAL FIELD

This disclosure relates to clamps used when connecting together conduit sections and fittings, such as sanitary fittings that transfer fluids for a manufacturing process, and methods for using such clamps to connect conduit sections.

### BACKGROUND

Maintaining sterility in manufacturing processes is often a concern. In one particular example applied in conventional manufacturing settings, receptacles with outlets provided by sanitary fittings are often required to interconnect with other sanitary fittings. These sanitary fittings are typically connected to lengths of conduit sections such as fluid transport tubing, for purposes of transferring contents (typically fluid) from one receptacle to another. To ensure the fluid transfer occurs under sterile conditions, the sanitary fittings at the terminal ends of the fluid transport tubing are clamped together along with a seal or gasket so that the fluid can be transferred between sections of tubing without leakage or other such exposure to the external environment.

Several types of clamps and clamping mechanisms for use with conduit sections and fittings are known. For example, clamps may be molded of a rigid plastic material and formed as a unitary piece or as two separate pieces connected together by coupling mechanisms.

### SUMMARY

According to an exemplary embodiment of the present disclosure, a clamp includes a first gland member having a first joint portion, a first locking portion, and a first clamping portion disposed between the first joint portion and the first locking portion and a second gland member having a second joint portion, a second locking portion, and a second clamping portion disposed between the second joint portion and the second locking portion. The first and second joint portions are connected for pivotable movement of the first and second gland members between an open position and at least one clamping position. The first locking portion is configured to interlock with the second locking portion to secure the first and second gland members in the at least one clamping position. The first and second locking portions further include corresponding first and second user manipulable release portions, independently operable for disengagement of the corresponding one of the first and second locking portions from the other of the first and second locking portions to permit movement of the first and second gland members to the open position.

According to another exemplary embodiment of the present disclosure, a clamp includes a first gland member having a first hinge portion, a first locking portion, and a first clamping portion disposed between the first hinge portion and the first locking portion, and a second gland member having a second hinge portion, a second locking portion, and a second clamping portion disposed between the second hinge portion and the second locking portion. The first and second hinge portions are connected for pivotable movement of the first and second gland members between an open position and at least one clamping position. The first hinge portion includes a first pin portion disposed on a first lateral side of the clamp and a first socket portion disposed on a second lateral side of the clamp, and the second hinge portion includes a second socket portion disposed on the first lateral side of the clamp and receiving the first pin portion, and a second pin portion disposed on the second lateral side of the claim and received in the first socket portion. The locking portion of each of the first and second gland members is configured to interlock with the locking portion of the other of the first and second gland members to secure the first and second gland members in the at least one clamping position.

According to another exemplary embodiment of the present disclosure, a clamp includes a first gland member having a first joint portion, a first locking portion and a first clamping portion extending longitudinally between the first joint portion and the first locking portion and a second gland member comprising a second joint portion, a second locking portion and a second clamping portion extending longitudinally between the second joint portion and the second locking portion. The first and second joint portions are connected for pivotable movement of the first and second gland members between an open position and at least one clamping position. When the first and second gland members are moved to the at least one clamping position, an interlock feature of the first locking portion interlocks with an interlock feature of the second locking portion to secure the first and second gland members in the at least one clamping position, and a longitudinally extending projection of the first locking portion is slidingly received into a longitudinally extending cavity of the second locking portion to secure the first locking portion against radial movement with respect to the second locking portion.

### BRIEF DESCRIPTION OF THE DRAWINGS

Further advantages and benefits will become apparent to those skilled in the art after considering the following description and appended claims in conjunction with the accompanying drawings, in which:

FIG. 1A is a side schematic view of a clamp in accordance with an exemplary embodiment of the present disclosure, shown in a closed condition;

FIG. 1B is a rear schematic view of the clamp of FIG. 1A;

FIG. 1C is a front schematic view of the clamp of FIG. 1A;

FIG. 2 is a front perspective view of a clamp in accordance with an exemplary embodiment of the present disclosure, shown in an open condition;

FIG. 3 is a front perspective view of the clamp of FIG. 2, shown in a closed or clamping condition;

FIG. 4 is a rear perspective view of the clamp of FIG. 2 in the closed condition;

FIG. 5 is a side view of the clamp of FIG. 2 in the closed condition;

FIG. 6 is a perspective view of one of the gland members of the clamp of FIG. 2;

FIG. 7 is an end cross-sectional view of the clamp of FIG. 2 in the closed condition;

FIG. 8 is a front perspective view of another clamp in accordance with another exemplary embodiment of the present disclosure, shown in an open condition;

FIG. 9 is a front perspective view of the clamp of FIG. 8, shown in a closed or clamping condition;

FIG. 10 is a rear perspective view of the clamp of FIG. 8 in the closed condition;

FIG. 11 is a side view of the clamp of FIG. 8 in the closed condition;

FIG. 12 is an enlarged partial side perspective view of the interlocking locking end portions of the clamp of FIG. 8 in the closed condition;

FIG. 13 is an exploded perspective view of the clamp of FIG. 8;

FIG. 14 is a front perspective view of another clamp in accordance with another exemplary embodiment of the present disclosure, shown in an open condition;

FIG. 15 is a front perspective view of the clamp of FIG. 14, shown in a closed or clamping condition;

FIG. 16 is a rear perspective view of the clamp of FIG. 14 in the closed condition;

FIG. 17 is a side view of the clamp of FIG. 14 in the closed condition;

FIG. 18 is a perspective view of one of the gland members of the clamp of FIG. 14;

FIG. 19 is a front perspective view of another clamp in accordance with another exemplary embodiment of the present disclosure, shown in an open condition;

FIG. 20 is a front perspective view of the clamp of FIG. 19, shown in a closed or clamping condition;

FIG. 21 is a rear perspective view of the clamp of FIG. 19 in the closed condition;

FIG. 22 is a side view of the clamp of FIG. 19 in the closed condition;

FIG. 23 is a perspective view of one of the first and second gland members of the clamp of FIG. 19; and

FIG. 24 is a perspective view of the third gland member of the clamp of FIG. 19.

### DETAILED DESCRIPTION

This Detailed Description merely describes exemplary embodiments and is not intended to limit the scope of the claims in any way. Indeed, the invention as claimed is broader than and unlimited by the described embodiments, and the terms used in the claims have their full ordinary meaning.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Clamps formed from two or more coupled gland members may include a user manipulable (e.g., hand graspable, tool engageable) release portion that may be pressed or otherwise moved by a user to disengage a locking portion (e.g., a flexible detent portion) of a first gland member from a locking portion (e.g., a generally rigid mating interlocking portion) of a second gland member. One such exemplary clamp including a flexible detent portion disengagable from a rigid interlocking portion is shown and described in co-owned U.S. Pat. No. 10,859,192, the entire disclosure of which is incorporated by reference herein.

According to an exemplary aspect of the present disclosure, a clamp may be configured to include first and second gland members each having a user manipulable release portion operable to disengage a locking portion of the corresponding gland member from a locking portion of the other gland member. In some such arrangements, manipulation of only one of the release portions may be sufficient to disengage the interlocking portions of the first and second gland members to open the clamp, resulting in easier operation of the clamp. In other arrangements, simultaneous user manipulation of both of the release portions may be required for disengagement of the locking portions and movement of the clamp to the open condition, providing for more secure or robust retention of the clamp on the conduit sections.

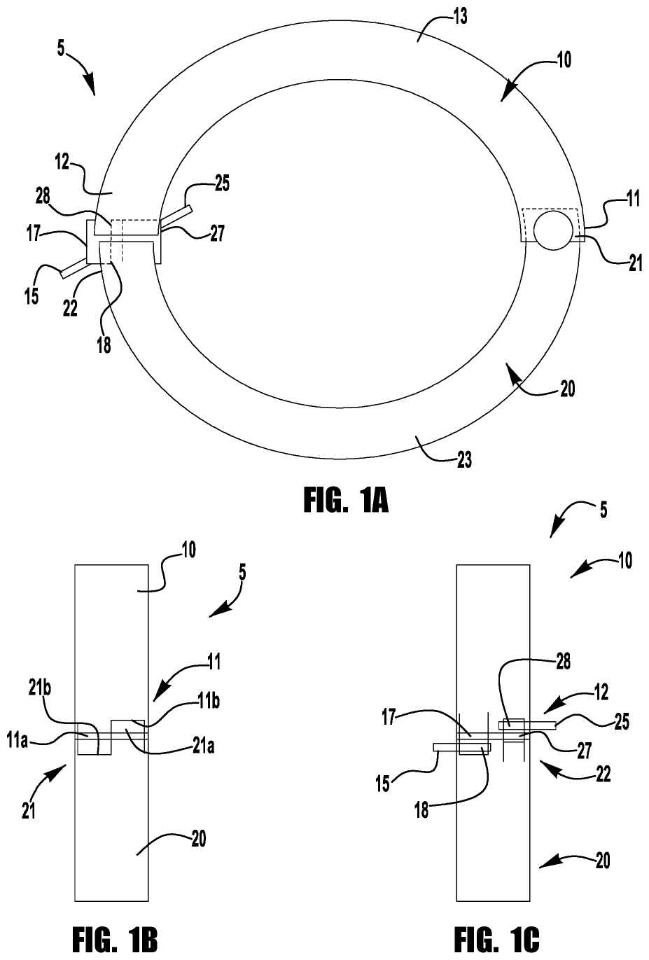

FIGS. 1A-1C schematically illustrate an exemplary clamp 5 including first and second gland members 10, 20 each including a joint portion 11, 21, a locking portion 12, 22, and a clamping portion 13, 23 between the joint portion and the locking portion. The clamping portion 13, 23 defines an inner peripheral recess for receiving and retaining flange portions of conduit sections joined by the clamp 5. The joint portions 11, 21 of the gland members 10, 20 are connected for movement (e.g., pivotable, camming, sliding, or some combination of these movements) of the gland members, relative to each other, between an open position and a closed or clamping position. The locking portion 12, 22 of each of the first and second gland members 10, 20 is configured to interlock with the locking portion of the other of the first and second gland members to secure the first and second gland members in the clamping position. The locking portion 12, 22 of each of the first and second gland members 10, 20 further includes a user manipulable release portion 15, 25, operable for disengagement of the locking portions 12, 22 to permit pivoting movement of the first and second gland members to the open position.

Many different types of locking portions may be utilized, including, for example, locking strap/tie arrangements, threaded bolt and clamping nut arrangements, and flexible detent arrangements. As one example, the locking portions 12, 22 of the schematically illustrated clamp 10 of FIGS. 1A-1C may include a flexible wall portion 17, 27 carrying at least one interlock feature (e.g., detent) 18, 28 configured to interlock with the locking portion of the other of the first and second gland members to secure the first and second gland members in the clamping position. In such an arrangement, the user manipulable release portion 15, 25 may be operable (e.g., by user grasping/squeezing, by use of a secondary tool) for movement of the corresponding flexible wall portion 17, 27, for flexing disengagement of the at least one detent 18, 28 from the locking portion of the other of the first and second gland members to permit pivoting movement of the first and second gland members to the open position.

Clamps formed from two or more coupled gland members conventionally include distinct, structurally distinguishable gland members having distinct and complementary joint portions and locking portions for connecting, coupling or otherwise engaging joint portions and locking portions of a mating gland member. The use of different, structurally distinct first and second gland members can result in increased manufacturing and inventory costs associated with having to make and store two different components. According to another exemplary aspect of the present disclosure, a clamp may be configured to include identical or substantially identical first and second gland members, for example, having identical or substantially identical joint, locking, and clamping portions, such that only one type of gland member needs to be made and stored for assembly of a clamp.

In the schematically illustrated embodiment of FIGS. 1A-1C, the joint portions 11, 21 of the first and second gland members 10, 20 may be identically or substantially identically formed with a first portion 11a, 21a (FIG. 1B) disposed on a first lateral side of the gland member 10, 20, and a second portion disposed on a second lateral side of the gland member, such that the mating joint portions have a genderless configuration. In this configuration, when the gland members 10, 20 are assembled with the joint portions 11, 21, locking portions 12, 22, and clamping portions 13, 23 in facing orientation to each other (i.e., with the first lateral side of the first gland member aligned with the second lateral side of the second gland member), the first joint portion 11a of the first gland member 10 laterally aligns with and couples with the second joint portion 21b of the second gland member 20, and the second joint portion 11b of the first gland member laterally aligns with and pivotably couples with the first joint portion 21a of the second gland member.

Likewise, the locking portions 12, 22 of the first and second gland members 10, 20 may be identically or substantially identical formed with an interlock feature (e.g., detent bearing flexible wall portion) 17 of the first gland member 10 aligning with interlocking detent(s) 29 of the second gland member 20, and with an interlock feature (e.g., detent bearing flexible wall portion) 27 of the second gland member aligning with interlocking portions of the first gland member, when the gland members are assembled in facing orientation to each other, for interlocking engagement of the detents 18, 28, such that the mating locking portions have a genderless configuration.

The locking portion configuration of flexible wall portions and interlocking detents may take a wide variety of forms. In one exemplary embodiment, the flexible wall portion may be disposed on a first lateral side of the gland member, with its detents extending laterally toward the second lateral side of the gland member. In some such configurations, when the gland members are assembled in facing orientation to each other (i.e., with the first lateral side of the first gland member aligned with the second lateral side of the second gland member), the laterally extending detents on the flexible wall portions interlock with each other when the gland members are pivoted to the closed position.

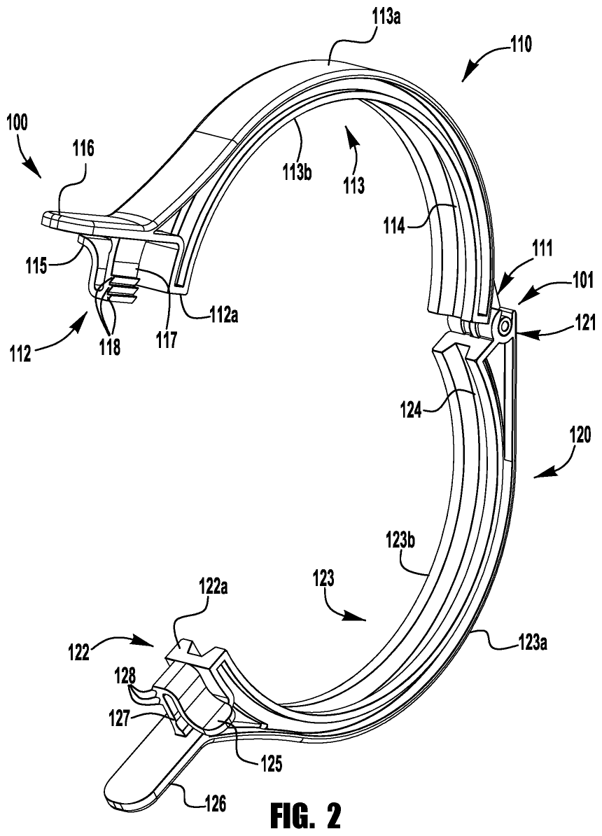

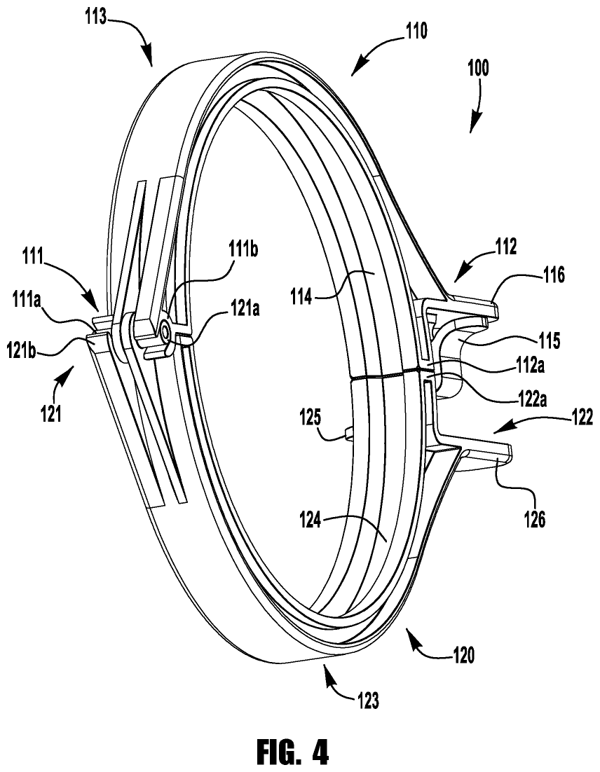

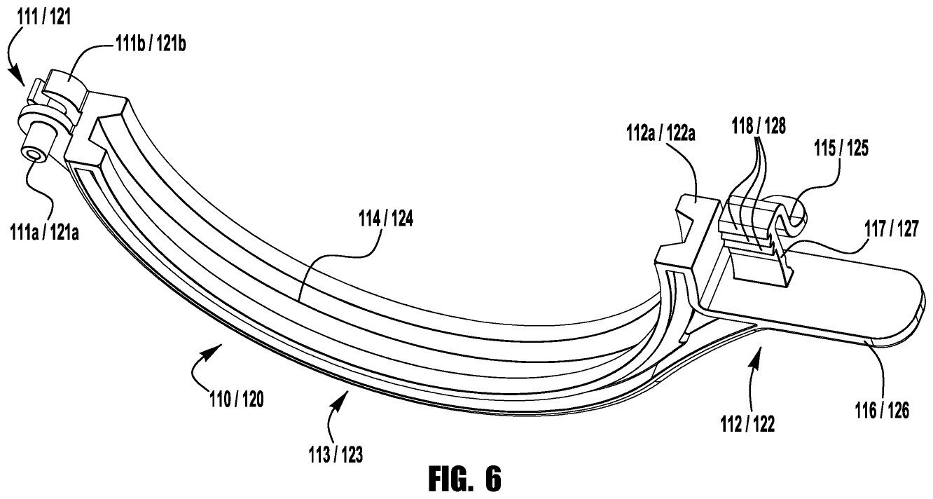

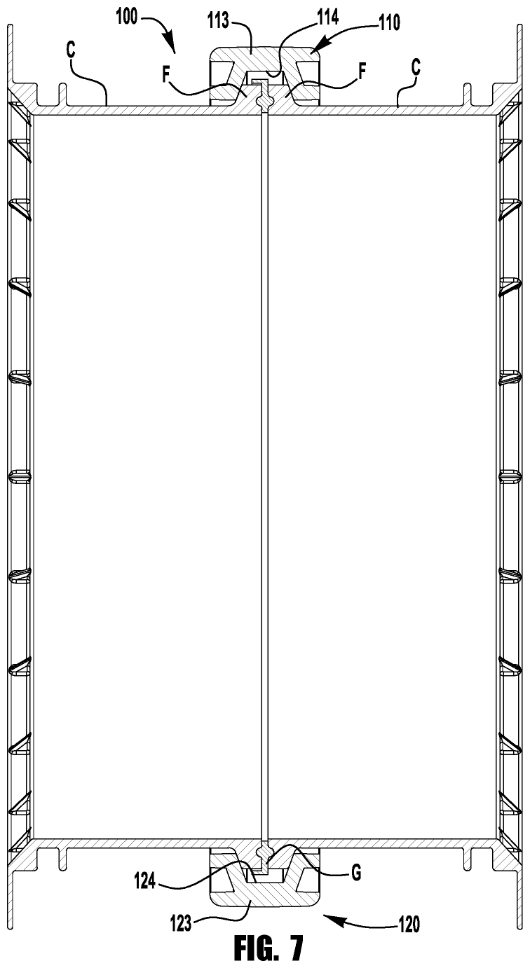

FIGS. 2 through 7 illustrate an exemplary embodiment of a clamp 100 used to join together two conduit sections C, such as, for example, flanged sanitary fittings (as shown in FIG. 7). The exemplary clamp 100 includes first and second gland members 110, 120 having pivotably connected joint or hinge portions 111, 121, releasably engageable locking portions 112, 122, and medial, arcuate clamping portions 113, 123 configured to form a circular closure around a circular structure (e.g., flanged ends of sanitary fittings) when the locking portions 112, 122 are secured together in a closed or clamping condition of the clamp 100, for example, to provide substantially uniform sealing pressure around the entire circular structure. In other embodiments, the clamp may be used to provide clamping engagement with other fittings or components, including, for example, components having a non-circular shape. Advantageously, the clamp 100 may be able to be re-opened and reused with different sets of conduit sections C, should that be desirable for the end user. In the illustrated embodiment, both gland members 110, 120 of the clamp 100 include a user manipulable (e.g., hand graspable, tool engageable) latch release arm or lever 115, 125 that may enable simplified disengagement of the gland member locking portions 112, 122, and/or more robust interlocking engagement of the locking portions of the gland members, as discussed in greater detail below. The clamp 100 may be configured such that extra tools and/or specialized equipment are not required to operate the clamp between open and closed positions, and the clamp and conduit sections C are not damaged or destroyed by the process of moving the clamp back to the open position. In some embodiments, the clamp 100 may be functional as a single-use clamp or as a reusable clamp. Further advantages are evidenced in the detailed discussion of this and other embodiments herein.

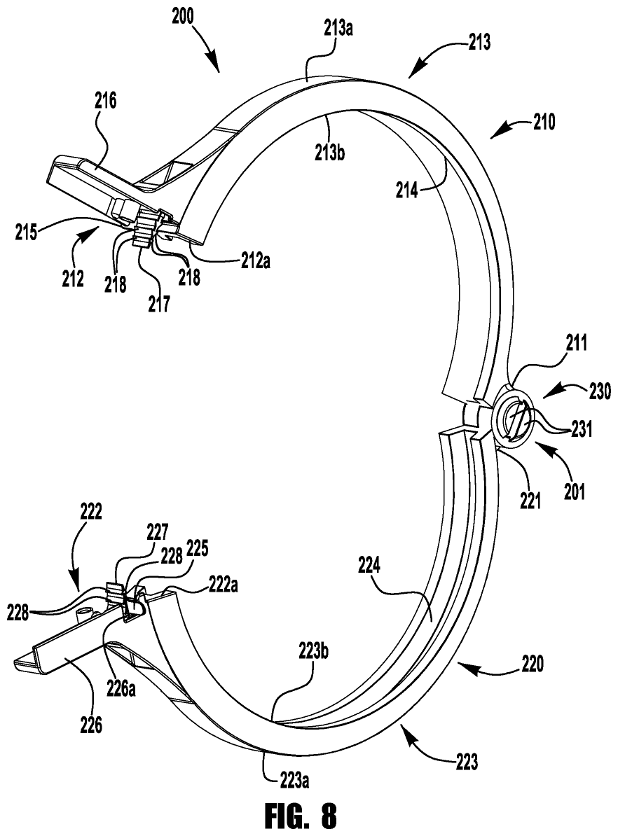

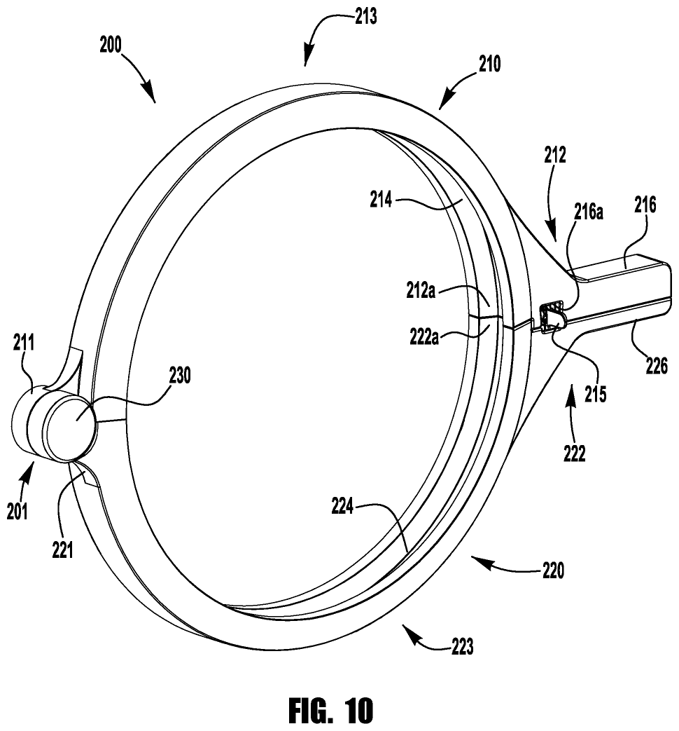

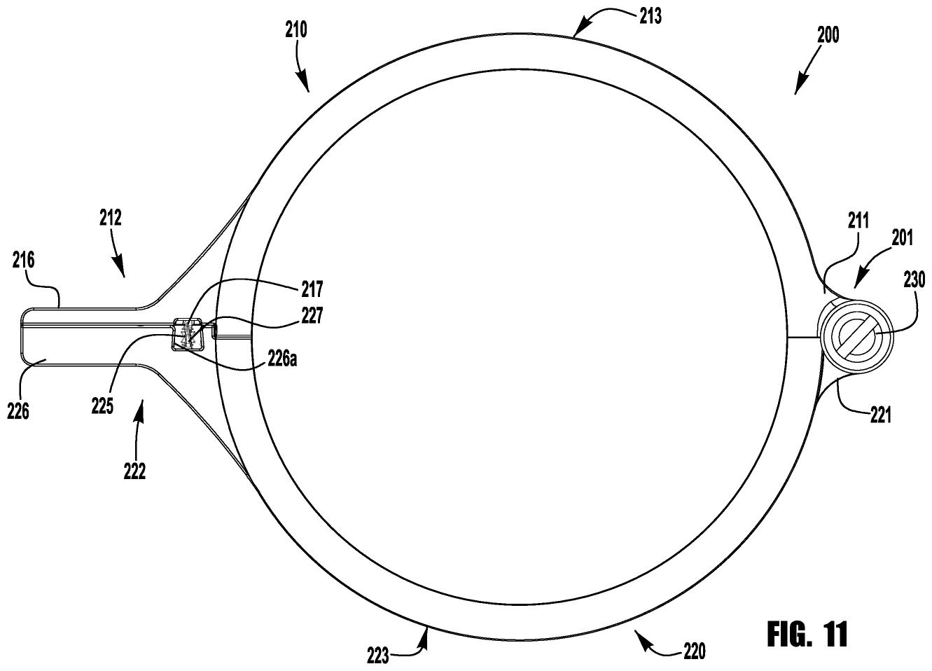

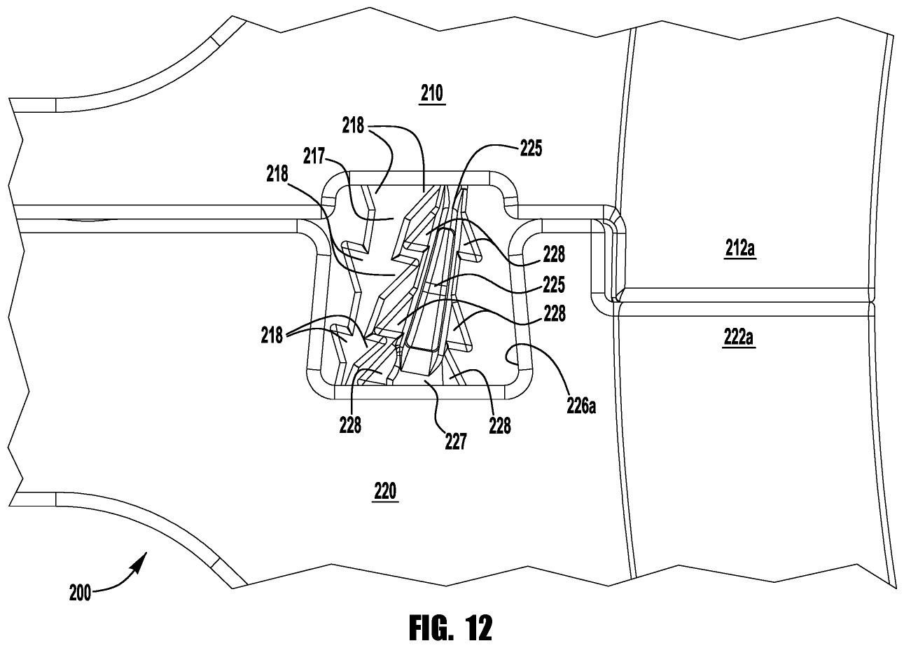

With particular reference to FIGS. 2 and 3-4, the clamp 100 is shown in an open position and in a closed position, respectively. In this embodiment, the first and second gland members 110, 120 of the clamp 100 are generally arcuate between a first end hinge portion 111, 121 and a second end locking portion 112, 122 opposite the first end. The corresponding hinge portions 111, 121 of the first and second gland members 110, 120 may be detachably joined, for example, by a hinge arrangement 101. While many suitable hinge arrangement structures may be used for pivotably connecting the hinge portions 111, 121 of the gland members 110, 120, in the illustrated embodiment, each hinge portion 111, 121 includes a pin portion 111a, 121a and an arcuate receptacle or recess or socket portion 111b, 121b, with the pin portion of each of the first and second gland members being received in the socket portion of the other of the first and second gland members for pivotable connection of the first and second gland members. As shown, the first and second gland members 110, 120 may be identically or substantially identically formed with the pin portion 111a, 111b disposed on a first lateral side of the gland member and the socket portion 111b, 121b disposed on a second lateral side of the gland member, such that the mating hinge portions have a genderless configuration. In this configuration, when the gland members 110, 120 are assembled with the hinge portions 111, 121, locking portions 112, 122, and clamping portions 113, 123 in facing orientation to each other (i.e., with the first lateral side of the first gland member aligned with the second lateral side of the second gland member), the pin portion 111a of the first gland member laterally aligns with and is received in the socket portion 121b of the second gland member, and the pin portion 121a of the second gland member laterally aligns with and is received in the socket portion 111b of the first gland member. The arcuate or barrel shaped socket portions 111b, 121b may include open ends having a width slightly smaller than a diameter of the pin portions 111a, 121a to retain the pin portions within the socket portions once the pin portions are pressed through the open ends. The open ends of the socket portions 111b, 121b may also be oriented to misalign with each other when the clamp is in the closed condition, to further impede separation of the hinge portions in this closed condition. In other embodiments (not shown), the clamp may utilize other hinge arrangements, including, for example, the apertured hasp and pivot pin hinge arrangement of the clamp 200 of FIGS. 8-13, described in greater detail below.

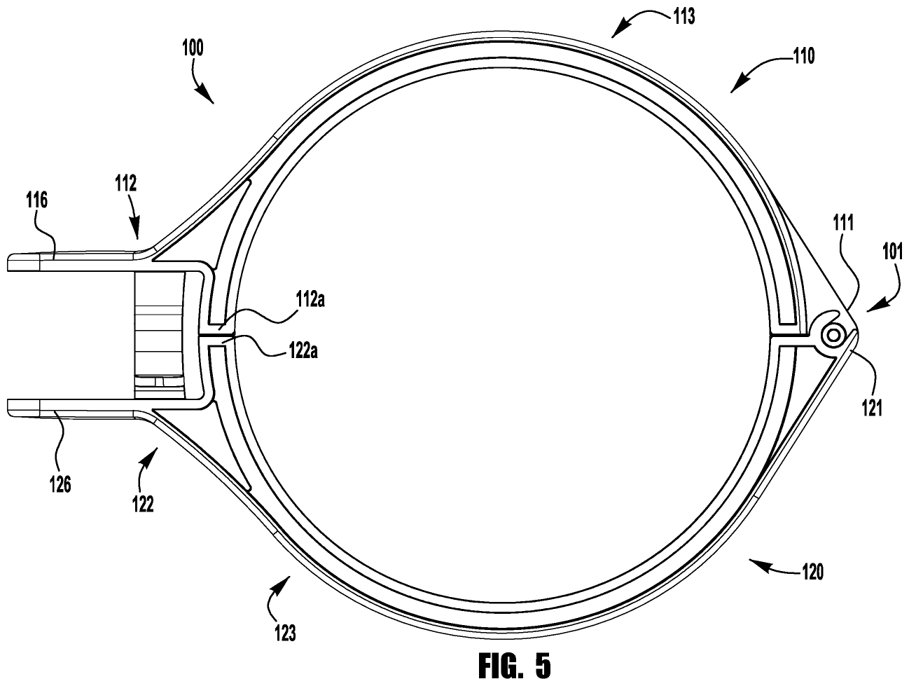

Between the hinge end portions 111, 121 and the locking end portions 112, 122, the gland members 110, 120 each define a generally semicircular or arcuate shaped clamping portion 113, 123 including an outer periphery 113a, 123a and an inner periphery 113b, 123b. Located along the inner periphery 113b, 123b is an arcuate channel or inner peripheral recess 114, 124 that is sized to receive the circular flanges F of the conduit sections C upon insertion of those flanges into the clamp 100. As shown, the exemplary inner peripheral recesses 114, 124 combine to form a substantially full (e.g., 350 to 360 degree) periphery around the circular flanges F when the conduit sections C are located in the clamp 100 and the clamp is in the closed or clamping condition. The inner peripheral recesses 114, 124 may be provided with any suitable shape or contour. In the illustrated embodiment, the arcuate inner peripheral recesses 114, 124 are configured to wedge the circular flanges F towards one another and towards the gasket G to form a sealed relationship in the state shown in FIG. 5. In other embodiments, the interior surface of the arcuate inner peripheral recesses may include toothed, notched, or hollow structures, for example, so as to save material when molding the first and second gland members 110, 120.

As illustrated in FIG. 2, the arcuate inner peripheral recesses 114, 124 may be exposed in the open condition of the clamp 100. In this regard, the clamp 100 may pivot open at least to a degree that enables the circular flanges F of the conduit sections C to be placed in, or withdrawn from, arcuate inner peripheral recesses 114, 124 of one of the first and second gland members 110, 120. Then the first and second gland members 110, 120 may be pivoted relative to each other about the hinge arrangement 101 to move into the closed condition of the clamp 100 so that the arcuate inner peripheral recesses 114, 124 engage the outer circumference of the circular flanges F. This arrangement therefore enables the conduit sections C to be securely held within the interior of the clamp 100 in the closed condition (FIG. 7).

The exemplary gland members 110, 120 further include handle portions 116, 126 projecting radially outward from the locking portions 112, 122 of the gland members, providing user graspable or grippable portions for user movement of the gland members between the open and closed conditions.

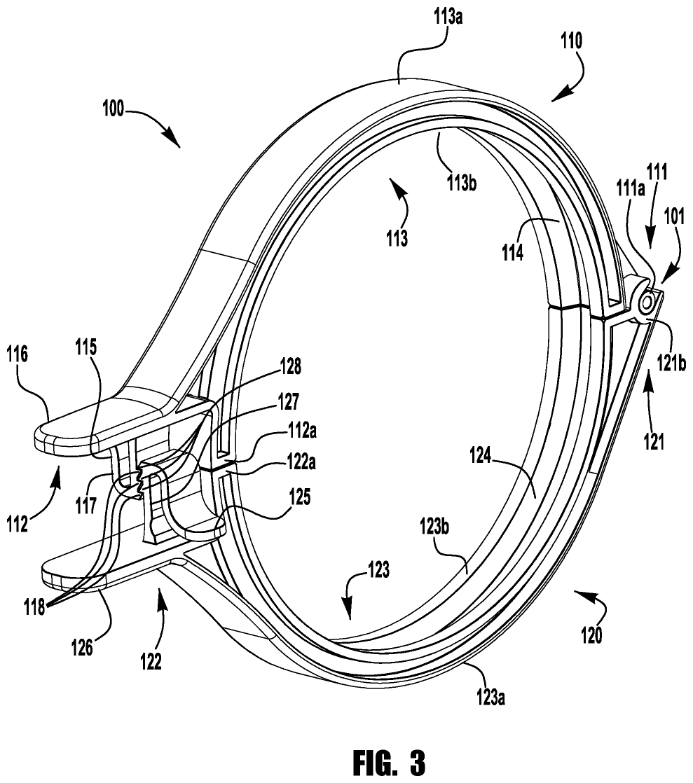

To securely close the clamp 100 on the conduit sections C, a user may grasp and squeeze the first and second handles 116, 126 towards one another to pivot the first and second gland members 110, 120 at the hinge arrangement 101 until end wall portions 112a, 122a of the locking portions 112, 122 are brought into abutment (e.g., into contact or close facing alignment) in the closed condition as shown in FIGS. 3-5. Once in the closed position, the exemplary first and second handles 116, 126 extend in the same general direction, such that the first and second handles may be generally parallel to one another in the closed condition of the clamp 100. However, it will be appreciated that the specific positioning and angling of the first and second handles may vary in other embodiments.

In order to reliably retain the clamp 100 in the closed condition, the gland members 110, 120 each include at least one interlock feature (e.g., detent) 118, 128 disposed on a flexible wall portion 117, 127 of the gland locking end portion 112, 122, for releasable interlocking engagement with the locking portion of the other gland member when the clamp is in the closed or clamping condition. In various embodiments, the at least one detent may be configured to interlock with a variety of structures on the locking end portion of the other gland member. In the illustrated embodiment of FIGS. 2-7, the at least one detent 118 of the first gland member 110 is positioned (e.g., with the flexible wall portion 117 extending from a base portion of the first handle 116) for interlocking engagement with the at least one detent 128 of the second gland member 120 (e.g., with the flexible wall portion 127 extending from a base portion of the second handle 126).

Extending from each of the flexible wall portions 117, 127 are user depressible lever portions 115, 125 for flexing disengagement of the at least one detent 118, 128 from the detent(s) 128, 118 of the other locking portion 122, 112 to permit movement of the first and second gland members 110, 120 to the open position. Depending on degree of flexibility of the flexible wall portions 117, 127, in some embodiments, user depression of only one of the lever portions 115, 125 may be sufficient for disengagement of the locking portions 112, 122 and movement of the clamp 100 to the open condition, providing for easier user removal of the clamp. In other embodiments, simultaneous user depression of both of the lever portions 115, 125 may be required for disengagement of the locking portions 112, 122 and movement of the clamp 100 to the open condition, providing for more secure or robust retention of the clamp 100 on the conduit sections C. In the illustrated embodiment, the lever portions 115, 125 are contoured to extend toward the clamping portion 113, 123 of the corresponding gland member 110, 120 (e.g., parallel to the flexible wall portion 117, 127) and laterally outward, such that a squeezing force applied to the lever portion 115, 125 and corresponding handle 116, 126 flexes the flexible wall portion 117, 127 laterally outward for disengagement of the detent(s) 118, 128. In other embodiments, the lever portion may be provided in a different orientation (e.g., coplanar with the flexible wall portion).

In the illustrated embodiment, each of the flexible wall portions 117, 127 includes three detents 118, 128, for example to provide multiple attachment points for more robust interlocking engagement, or to provide multiple ratcheting closed conditions. In other embodiments, fewer or more detents may be provided on either or both of the flexible wall portions.

Each of the detents 118, 128 may protrude laterally as stepped ridges or teeth from the corresponding flexible wall portion 117, 127. More specifically, each of the detents 118, 128 includes an angled front surface facing towards the distal end of the flexible wall and a transverse rear surface facing towards the proximal end of the flexible wall. These front and rear surfaces enable snap-over or ratcheting engagement of the first and second gland detents 118, 128. It will be understood that the particular angling of the angled front surface and the transverse rear surface may be modified in other embodiments while still enabling interlocking engagement.

The exemplary gland members 110, 120 are each integrally molded or otherwise formed to be a unitary piece of plastic material, such as, for example, nylon. In such an embodiment, the hinge portion 111, 121, the locking portion 112, 122, the clamping portion 113, 123, the handle 116, 126, the flexible wall portion 117, 127, and the lever portion 115, 125 of each gland 110, 120 are one unitary piece of material with enough flexibility to enable the flexing or pivoting movement of the flexible wall portion 117, 127 with respect to the locking portion 112, 122, but with sufficient rigidity to hold the circular flanges F of the conduit sections C in reliable sealed engagement when the clamp 100 is in the closed position. The specific materials and method of manufacturing for the first and second gland members 110, 120 may be modified to suit the needs and preferences of end users.

While the gland members may be formed as structurally distinct components, in the exemplary embodiment of FIGS. 2-7, the exemplary gland members 110, 120 are molded or otherwise formed as identical or substantially identical gland components, for example, to allow for use of a single mold to form both gland members, and to allow for storage of a single type of gland member for production of the clamp 100. As discussed above, when the gland members are oriented for assembly (with the hinge portions 111, 121 and locking portions 112, 122 facing each other), the pin portion 111a of the first gland member 110 aligns with and is received in the socket portion 121b of the second gland member 120, and the pin portion 121a of the second gland member aligns with and is received in the socket portion 111b of the first gland member. Likewise, the detents 118 of the first gland member 110 laterally align with the detents 128 of the second gland member 120 for flexing and ratcheting interlocking engagement of the detents 118, 128 when the gland members are pivoted to the clamp's closed condition.

When in use, a user can move the clamp 100 to the closed position by grasping the handle portions 116, 126 and drawing (e.g., pushing, pulling, squeezing) the handle portions towards one another. This movement of the handle portions 116, 126 causes relative movement of locking end portions 112, 122 of the first and second gland members 110, 120 towards one another as a result of the pivotal coupling at the hinge arrangement 101. During this pivotal movement, the first gland member detents 118 begin snapping over the second gland member detents 128. To this end, as the first and second gland members 110, 120 move towards each other from the open position of FIG. 2 to the closed, latched position of FIG. 3, the first and second locking detents 118, 128 may slide along and past each other until the abutting engagement between the end wall portions 112a, 122a of the locking portions 112, 122, or until sufficient clamping force is applied to the flange ends F and gasket G (which may, but need not, correspond with contacting abutment of the end wall portions). This clamped condition may also correspond to when the most proximal of the first locking detents 118 on the first flexible wall portion 117 meshes with a most proximal of the second locking detents 128 on the second flexible wall portion 127. Due to the close abutment or contact between the end wall portions 112a, 122a in this closed condition, a substantially full (e.g., 350 to 360 degree) peripheral engagement of the circular flanges F may be provided. After the first and second handles 116, 126 are squeezed together to make the end wall portions 112a, 122a of the first and second gland members 110, 120 abut in the closed position, the first and second locking detents 118, 128 are fully meshed with one another so that the corresponding transverse rear surfaces of the toothed detents engage to retain the clamp 100 in the closed position.

To loosen or disassemble the clamp 100 from the conduit sections C (e.g., to separate the conduit sections, or to replace one or more of the conduit sections and the gasket G), either or both of the lever portions 115, 125 are depressed for flexing disengagement of the at least one detent 118, 128 from the detent(s) 128, 118 of the other locking portion 122, 112 to permit movement of the first and second gland members 110, 120 toward the open position.

In another exemplary embodiment, the flexible wall portion may extend laterally across the gland member, with its detents extending radially, toward or away from central portion of the clamp. In some such configurations, when the gland members are assembled in facing orientation to each other (i.e., with the first lateral side of the first gland member aligned with the second lateral side of the second gland member), the radially extending detents on the laterally extending flexible wall portions interlock with each other when the gland members are pivoted to the closed position.

FIGS. 8 through 13 illustrate another exemplary embodiment of a clamp 200 used to join together two conduit sections, such as, for example, flanged sanitary fittings. The exemplary clamp 200 includes first and second gland members 210, 220 having pivotably connected joint or hinge portions 211, 221, releasably engageable locking portions 212, 222, and medial, arcuate clamping portions 213, 223 configured to form a circular closure around a circular structure (e.g., flanged ends of sanitary fittings) when the locking portions 212, 222 are secured together in a closed or clamping condition of the clamp 200, for example, to provide substantially uniform sealing pressure around the entire circular structure. In other embodiments, the clamp may be used to provide clamping engagement with other fittings or components, including, for example, components having a non-circular shape. Advantageously, the clamp 200 may be able to be re-opened and reused with different sets of conduit sections, should that be desirable for the end user. In the illustrated embodiment, both gland members 210, 220 of the clamp 200 include a user manipulable (e.g., hand graspable, tool engageable) latch release arm or lever 215, 225 that may enable simplified disengagement of the gland member locking portions 212, 222, and/or more robust interlocking engagement of the locking portions of the gland members, as discussed in greater detail below. The clamp 200 may be configured such that extra tools and/or specialized equipment are not required to operate the clamp between open and closed positions, and the clamp and conduit sections are not damaged or destroyed by the process of moving the clamp back to the open position. In some embodiments, the clamp 200 may be functional as a single-use clamp or as a reusable clamp. Further advantages are evidenced in the detailed discussion of this and other embodiments herein.

With particular reference to FIGS. 8 and 9-12, the clamp 200 is shown in an open position and in a closed position, respectively. In this embodiment, the first and second gland members 210, 220 of the clamp 200 are generally arcuate between a first end hinge portion 211, 221 and a second end locking portion 213, 223 opposite the first end. The corresponding hinge portions 211, 221 of the first and second gland members 210, 220 may be detachably joined, for example, by a hinge arrangement 201. While many suitable hinge arrangement structures may be used for pivotably connecting the hinge portions 211, 221 of the gland members 210, 220, in the illustrated embodiment, each hinge portion 211, 221 is identically or substantially identically formed with an apertured hasp portion 211a, 221a disposed on a first lateral side of the gland member. In this configuration, when the gland members 210, 220 are assembled with the hinge portions 211, 221, locking portions 212, 222, and clamping portions 213, 223 in facing orientation to each other (i.e., with the first lateral side of the first gland member aligned with the second lateral side of the second gland member), the apertured hasp portions 211a, 221a align with each other to receive a pivot pin 230 therethrough, to secure the hinge portions 211, 221 together as a pivotable hinge arrangement 201. While many suitable pivot pins may be used, the illustrated pivot pin 230 includes resilient fingers 231 deformable for insertion of the pivot pin through the aligned apertures. In other embodiments (not shown), a clamp similar to the clamp 200 of FIGS. 8-13 may instead utilize a hinge arrangement similar to the hinge arrangement 101 of the clamp 100 of FIGS. 2-7.

Between the hinge end portions 211, 221 and the locking end portions 212, 222, the gland members 210, 220 each define a generally semicircular or arcuate shaped clamping portion 213, 223 including an outer periphery 213a, 223a and an inner periphery 213b, 223b. Located along the inner periphery 213b, 223b is an arcuate channel or inner peripheral recess 214, 224 that is sized to receive the circular flanges of the conduit sections upon insertion of those flanges into the clamp 200. As shown, the exemplary inner peripheral recesses 214, 224 combine to form a substantially full (e.g., 350 to 360 degree) periphery around the circular flanges when the conduit sections are located in the clamp 200 and the clamp is in the closed or clamping condition. The inner peripheral recesses 214, 224 may be provided with any suitable shape or contour. In the illustrated embodiment, the arcuate inner peripheral recesses 214, 224 are configured to wedge the circular flanges towards one another and towards the gasket to form a sealed relationship, similar to the arrangement shown in FIG. 7. In other embodiments, the interior surface of the arcuate inner peripheral recesses may include toothed, notched, or hollow structures, for example, so as to save material when molding the first and second gland members 210, 220.

The exemplary gland members 210, 220 further include handle portions 216, 226 projecting radially outward from the locking portions 212, 222 of the gland members, providing user graspable or grippable portions for user movement of the gland members between the open and closed conditions.

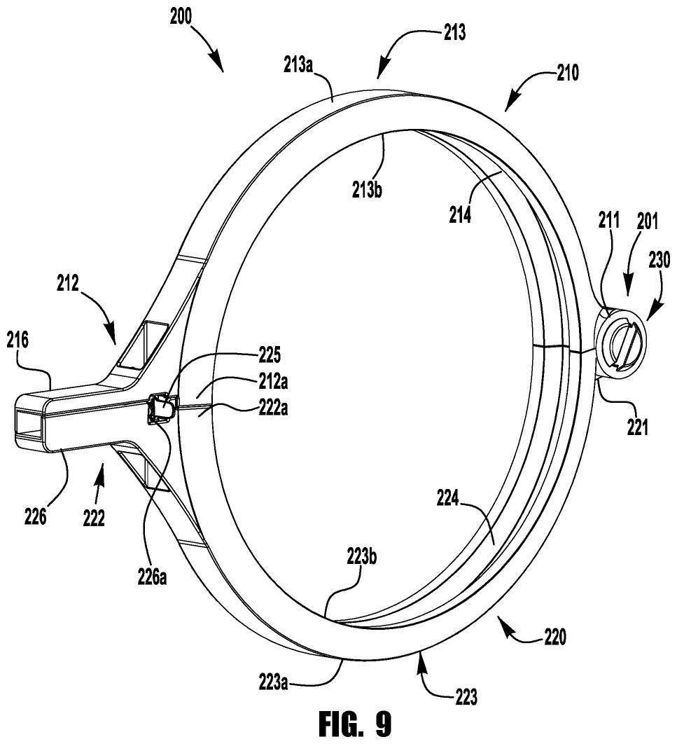

To securely close the clamp 200 on the conduit sections, a user may grasp and squeeze the first and second handles 216, 226 towards one another to pivot the first and second gland members 210, 220 at the hinge arrangement 201 until the end wall portions 212a, 222a of the locking portions 212, 222 are brought into abutment (e.g., into contact or close facing alignment) in the closed condition as shown in FIGS. 9-12. Once in the closed position, the exemplary first and second handles 216, 226 substantially overlap with each other, with L-shaped cross-sectional walls of the handles abutting each other to form a single handle arrangement. However, it will be appreciated that the specific positioning and angling of the first and second handles may vary in other embodiments.

In order to reliably retain the clamp 200 in the closed condition, the gland members 210, 220 each include at least one radially extending interlock feature (e.g., detent) 218, 228 disposed on a laterally extending flexible wall portion 217, 227 of the gland locking end portion 212, 222, for releasable interlocking engagement with the locking portion of the other gland member when the clamp is in the closed or clamping condition. In various embodiments, the at least one detent may be configured to interlock with a variety of structures on the locking end portion of the other gland member. In the illustrated embodiment of FIGS. 8-13, the at least one detent 218 of the first gland member 210 is positioned (e.g., with the flexible wall portion 217 extending from a base portion of the first handle 216) for interlocking engagement with the at least one detent 228 of the second gland member 220 (e.g., with the flexible wall portion 227 extending from a base portion of the second handle 226). As one example, the at least one detent 218 of the first gland member 210 extends radially outward from the first flexible wall portion 217, and the at least one detent 228 of the second gland member 220 extends radially inward from the second flexible wall portion 227, such that in the closed condition of the clamp 200, the first flexible wall portion bends radially inward and the second flexible wall portion bends radially outward for ratcheting interlocking engagement of the facing detents.

Extending from each of the flexible wall portions 217, 227 are user depressible lever portions 215, 225 for flexing disengagement of the at least one detent 218, 228 from the detent(s) 228, 218 of the other locking portion 222, 212 to permit movement of the first and second gland members 210, 220 to the open position. Depending on degree of flexibility of the flexible wall portions 217, 227, in some embodiments, user depression of only one of the lever portions 215, 225 may be sufficient for disengagement of the locking portions 212, 222 and movement of the clamp 200 to the open condition, providing for easier user removal of the clamp. In other embodiments, simultaneous user depression of both of the lever portions 215, 225 may be required for disengagement of the locking portions 212, 222 and movement of the clamp 200 to the open condition, providing for more secure or robust retention of the clamp 200 on the conduit sections. In the illustrated embodiment, the lever portions 215, 225 extend laterally outward from the flexible wall portions 217, 227 through cutouts 216a, 226a in the handles 216, 226, and may be substantially coplanar with the flexible wall portions, as shown. A radial pressing force applied to one or both of the lever portions 215, 225 flexes the flexible wall portion 217, 227 radially apart from each other for disengagement of the detent(s) 218, 228. In other embodiments, the lever portion may be provided in a different orientation.

In the illustrated embodiment, each of the flexible wall portions 217, 227 includes three detents 218, 228, for example to provide multiple attachment points for more robust interlocking engagement, or to provide multiple ratcheting closed conditions. In other embodiments, fewer or more detents may be provided on either or both of the flexible wall portions.

While the first gland member 210 may be provided with only radially outward extending detents 218 and the second gland member 220 may be provided with only radially inward extending detents 228, in the illustrated embodiment, the first gland member also includes detents 218 extending radially inward from an opposite side of the first flexible wall portion 217, and the second gland member also includes detents 228 extending radially outward from an opposite side of the second flexible wall portion 227. By using such an arrangement, the gland member locking portions 212, 222 may also interlock by radially outward bending of the first flexible wall portion 217 and radially inward bending of the second flexible wall portion 227. By providing the flexible wall portions 217, 227 with relatively thin leading edge portions, inherent slight radial misalignment of these leading edge portions during clamp closure may cause either of the flexible wall portions 217, 227 to bend radially outward, and the other of the flexible wall portions to bend radially inward, depending on the direction of radial misalignment. In the absence of any radial misalignment of the flexible wall portions 217, 227, a user applied force to one of the lever portions 215, 225 may produce sufficient radial alignment during closure for radial bending of the flexible wall portions and ratcheting interlocking engagement of the corresponding detents 218, 228.

Each of the detents 218, 228 may protrude radially as stepped ridges or teeth from the corresponding flexible wall portion 217, 227. More specifically, each of the illustrated detents 218, 228 includes an angled front surface facing towards the distal end of the flexible wall and a transverse rear surface facing towards the proximal end of the flexible wall. These front and rear surfaces enable snap-over or ratcheting engagement of the first and second gland detents 218, 228. It will be understood that the particular angling of the angled front surface and the transverse rear surface may be modified in other embodiments while still enabling interlocking engagement.

The exemplary gland members 210, 220 are each integrally molded or otherwise formed to be a unitary piece of plastic material, such as, for example, nylon. In such an embodiment, the hinge portion 211, 221, the locking portion 212, 222, the clamping portion 213, 223, the handle 216, 226, the flexible wall portion 217, 227, and the lever portion 215, 225 of each gland 210, 220 are one unitary piece of material with enough flexibility to enable the flexing or pivoting movement of the flexible wall portion 217, 227 with respect to the locking portion 212, 222, but with sufficient rigidity to hold the circular flanges of the conduit sections in reliable sealed engagement when the clamp 200 is in the closed position. The specific materials and method of manufacturing for the first and second gland members 210, 220 may be modified to suit the needs and preferences of end users.

Additionally, the exemplary gland members 210, 220 may be molded or otherwise formed as identical or substantially identical gland components, for example, to allow for use of a single mold to form both gland members, and to allow for storage of a single type of gland member for production of the clamp 200. As discussed above, when the gland members are oriented for assembly (with the hinge portions 211, 221 and locking portions 212, 222 facing each other), the apertured hasp portions 211a, 221a of the first and second gland members 210, 220 align to receive the pivot pin 230. Likewise, the detents 218 of the first gland member 210 laterally align with the detents 228 of the second gland member 220 for flexing and ratcheting interlocking engagement of the detents 218, 228 when the gland members are pivoted to the clamp's closed condition.

According to another exemplary aspect of the present disclosure, the locking portions of first and second gland members of a clamp may include reinforcing portions that engage with each other when the locking portions are brought into abutment in the clamp's clamping position, for example, to facilitate alignment of interlocking features (e.g., toothed detents) and/or to reinforce the locking portions against damage or accidental disengagement, due to dropping or other such impact. For example, a projection extending longitudinally from the locking portion of one of the first and second gland members may be slidably received into a longitudinally extending cavity in the locking portion of the other of the first and second gland members when the first and second gland members are moved to the clamping position. In exemplary embodiments using identical or substantially identical first and second gland members, each of the first and second gland members may include a projection extending longitudinally from the locking portion that is slidably received into a longitudinally extending cavity in the locking portion of the other of the first and second gland members.

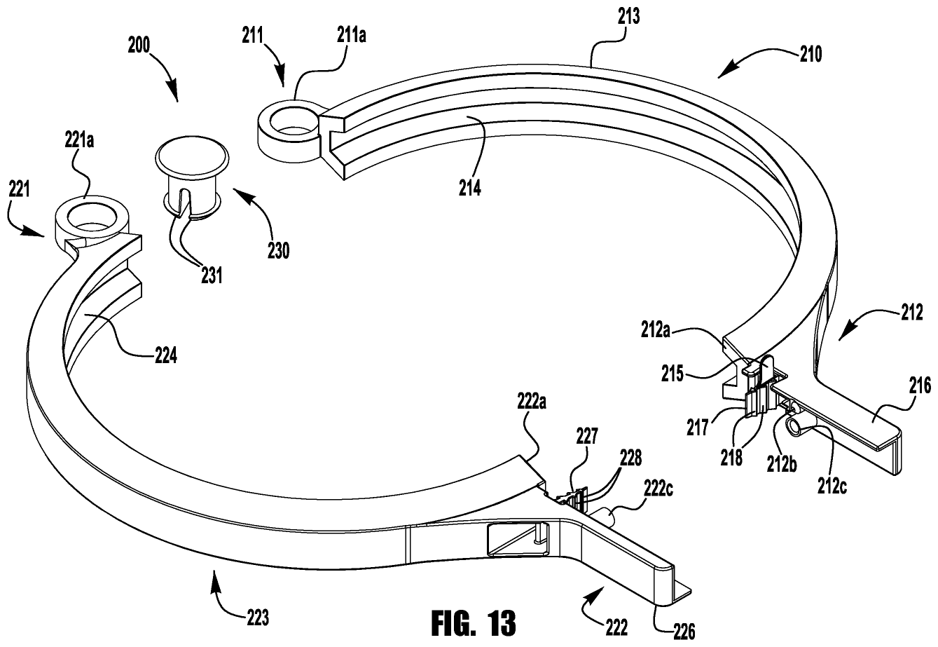

In the exemplary clamp of FIGS. 8-13, as best shown in FIGS. 8 and 13, the locking portions 212, 222 of each gland member 210, 220 includes longitudinally extending, mating projection (e.g., pin) portions 212b, 222b engageable with the cavity (e.g., socket) portions 222c, 212c of the other gland member, for example, to facilitate adequate radial alignment of the locking portions in the clamp's closed condition. Similar reinforcing portions may be provided in the other clamp embodiments shown and described herein.

When in use, a user can move the clamp 200 to the closed position by grasping the handle portions 216, 226 and drawing (e.g., pushing, pulling, squeezing) the handle portions towards one another. This movement of the handle portions 216, 226 causes relative movement of locking end portions 212, 222 of the first and second gland members 210, 220 towards one another as a result of the pivotal coupling at the hinge arrangement 201. During this pivotal movement, the reinforcing projections 212b, 222b of each locking portion 212, 222 are received in the reinforcing cavities 222c, 212c of the other locking portion, and the first gland member detents 218 begin snapping over the second gland member detents 228. To this end, as the first and second gland members 210, 220 move towards each other from the open position of FIG. 8 to the closed, latched position of FIGS. 9-12, the first and second locking detents 218, 228 may slide along and past each other until the abutting engagement between the end wall portions 212a, 222a of the locking portions 212, 222, or until sufficient clamping force is applied to the flange ends and gasket (which may, but need not, correspond with contacting abutment of the end wall portions). This clamped condition may also correspond to when the most proximal of the first locking detents 218 on the first flexible wall portion 217 meshes with a most proximal of the second locking detents 228 on the second flexible wall portion 227. Due to the close abutment or contact between the end wall portions 212a, 222a in this closed condition, a substantially full (e.g., 350-360 degree) peripheral engagement of the circular flanges may be provided. After the first and second handles 216, 226 are squeezed together to make the end wall portions 212a, 222a of the first and second gland members 210, 220 abut in the closed position, the first and second locking detents 218, 228 are fully meshed with one another so that the corresponding transverse rear surfaces of the toothed detents engage to retain the clamp 200 in the closed position.

To loosen or disassemble the clamp 200 from the conduit sections (e.g., to separate the conduit sections, or to replace one or more of the conduit sections and the gasket), either or both of the lever portions 215, 225 are depressed for flexing disengagement of the at least one interlock feature (e.g., detent) 218, 228 from the detent(s) 228, 218 of the other locking portion 222, 212 to permit movement of the first and second gland members 210, 220 toward the open position.

In another exemplary embodiment, each gland member may include a flexible wall portion, with radially extending detents, extending laterally across a first lateral side of the gland member, and an interlocking wall portion, with opposed radially extending detents, extending laterally across a second lateral side of the gland member. In some such configurations, when the gland members are assembled in facing orientation to each other (i.e., with the first lateral side of the first gland member aligned with the second lateral side of the second gland member), the radially extending detents on the laterally extending flexible wall portion of each gland member interlock with the radially extending detents on the interlocking wall portion of the other gland member when the gland members are pivoted to the closed position.

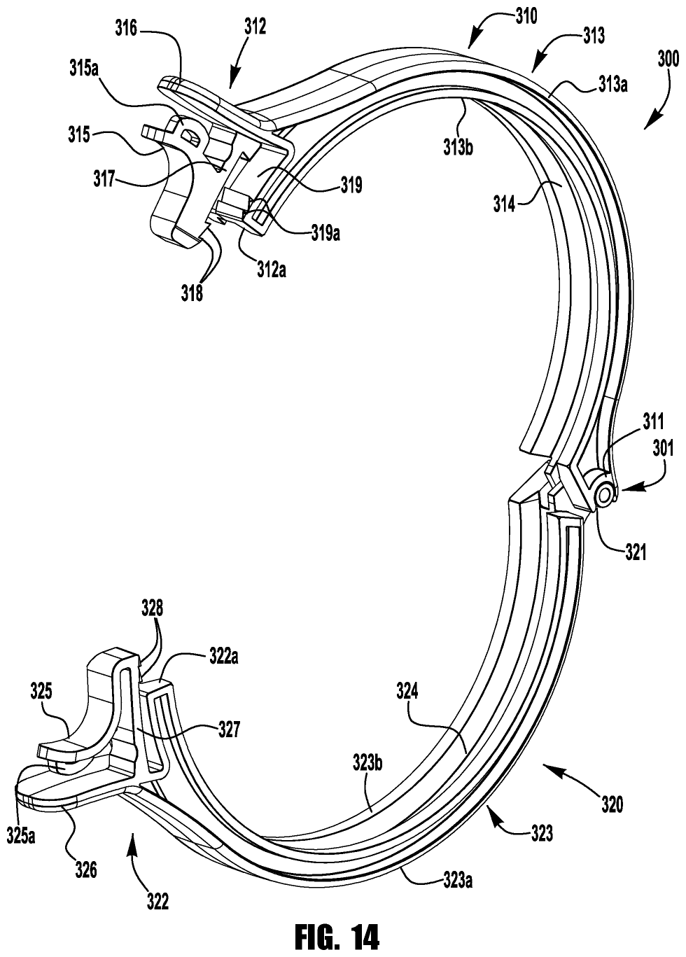

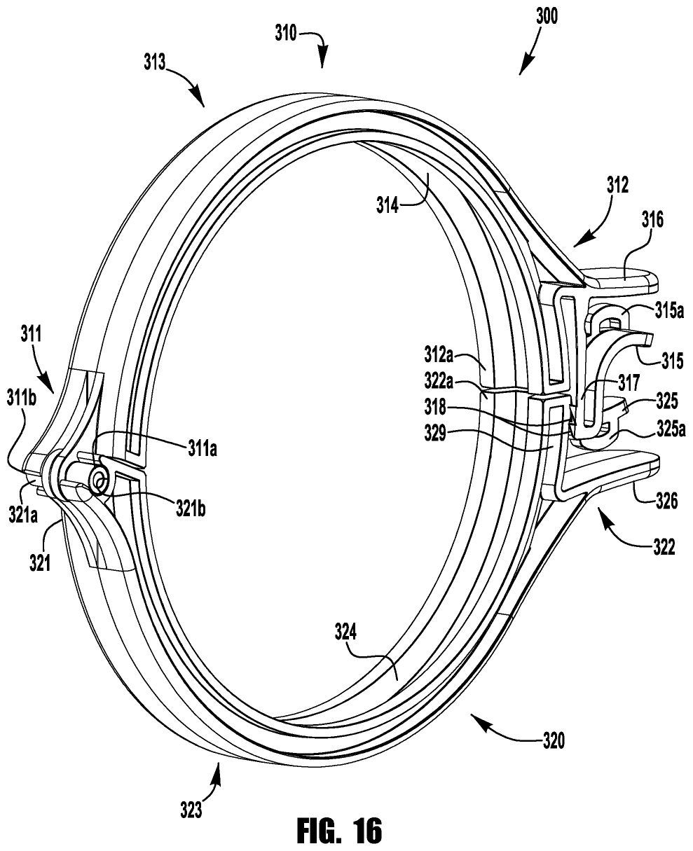

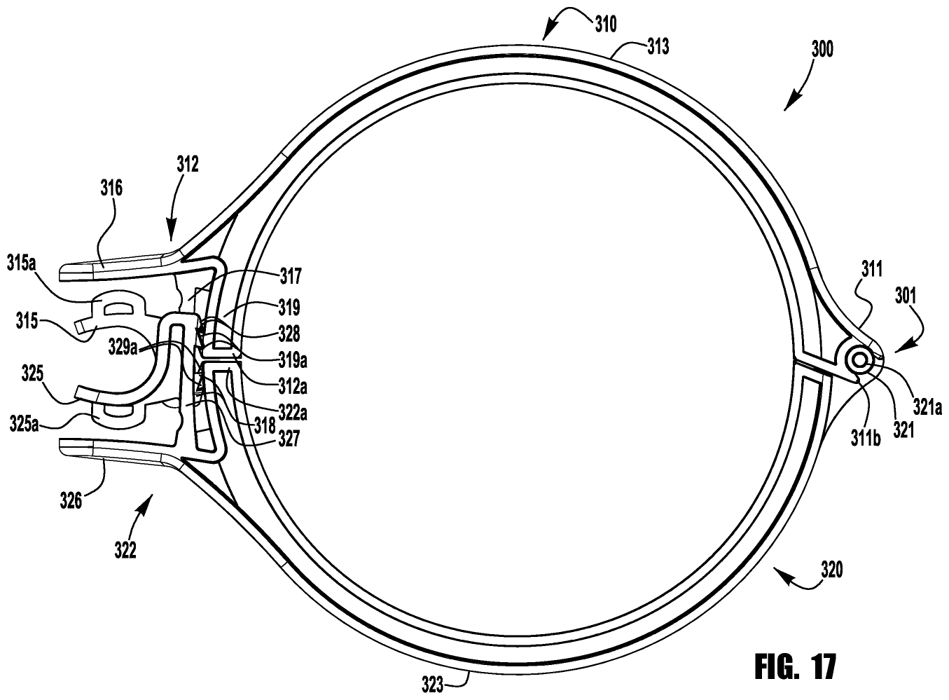

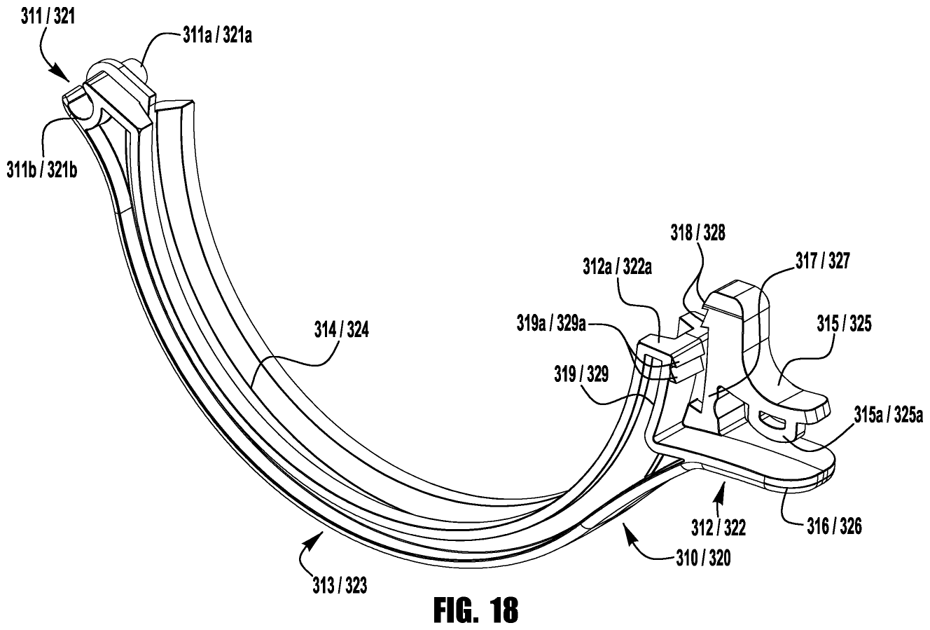

FIGS. 14 through 18 illustrate another exemplary embodiment of a clamp 300 used to join together two conduit sections, such as, for example, flanged sanitary fittings. The exemplary clamp 300 includes first and second gland members 310, 320 having pivotably connected joint or hinge portions 311, 321, releasably engageable locking portions 312, 322, and medial, arcuate clamping portions 313, 323 configured to form a circular closure around a circular structure (e.g., flanged ends of sanitary fittings) when the locking portions 312, 322 are secured together in a closed or clamping condition of the clamp 300, for example, to provide substantially uniform sealing pressure around the entire circular structure. In other embodiments, the clamp may be used to provide clamping engagement with other fittings or components, including, for example, components having a non-circular shape. Advantageously, the clamp 300 may be able to be re-opened and reused with different sets of conduit sections, should that be desirable for the end user. In the illustrated embodiment, both gland members 310, 320 of the clamp 300 include a user manipulable (e.g., hand graspable, tool engageable) latch release arm or lever 315, 325 that may enable simplified disengagement of the gland member locking portions 312, 322, and/or more robust interlocking engagement of the locking portions of the gland members. The clamp 300 may be configured such that extra tools and/or specialized equipment are not required to operate the clamp between open and closed positions, and the clamp and conduit sections are not damaged or destroyed by the process of moving the clamp back to the open position. In some embodiments, the clamp 300 may be functional as a single-use clamp or as a reusable clamp. Further advantages are evidenced in the detailed discussion of this and other embodiments herein.

With particular reference to FIGS. 14 and 15-17, the clamp 300 is shown in an open position and in a closed position, respectively. In this embodiment, the first and second gland members 310, 320 of the clamp 300 are generally arcuate between a first end hinge portion 311, 321 and a second end locking portion 312, 322 opposite the first end. The corresponding hinge portions 311, 321 of the first and second gland members 310, 320 may be detachably joined, for example, by a hinge arrangement 301. While many suitable hinge arrangement structures may be used for pivotably connecting the hinge portions 311, 321 of the gland members 310, 320, in the illustrated embodiment, each hinge portion 311, 321 includes a pin portion 311a, 321a and an arcuate receptacle or socket portion 311b, 321b, similar to the hinge arrangement 101 of the clamp 100 of FIGS. 2-7, described in greater detail above. In other embodiments (not shown), the clamp may utilize other hinge arrangements, including, for example, the apertured hasp and pivot pin hinge arrangement of the clamp 200 of FIGS. 8-13, described in greater detail above.

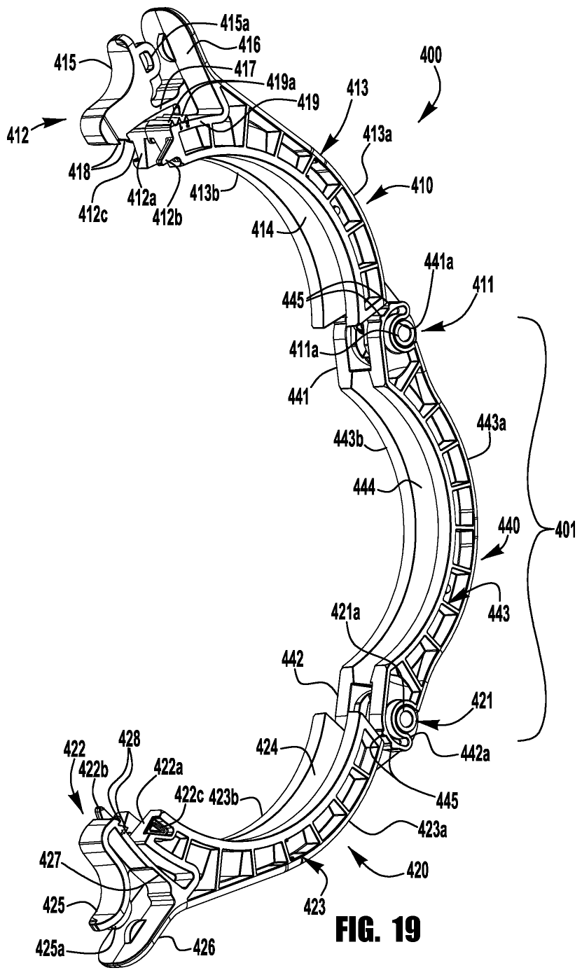

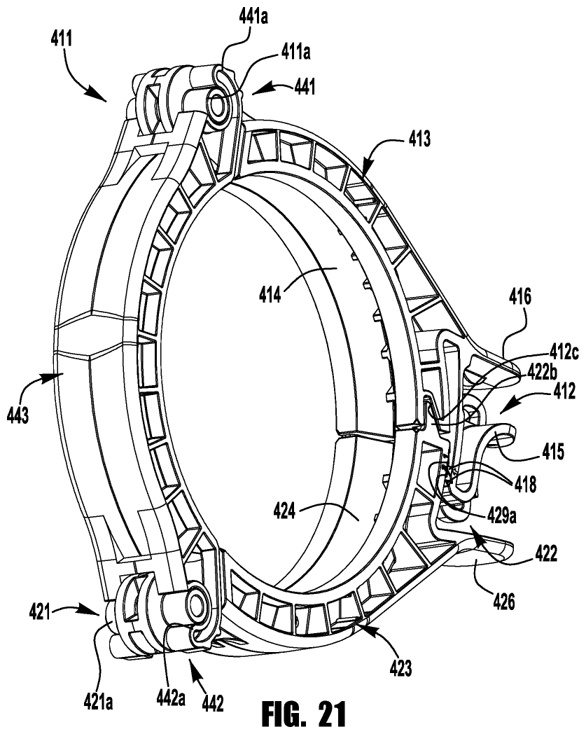

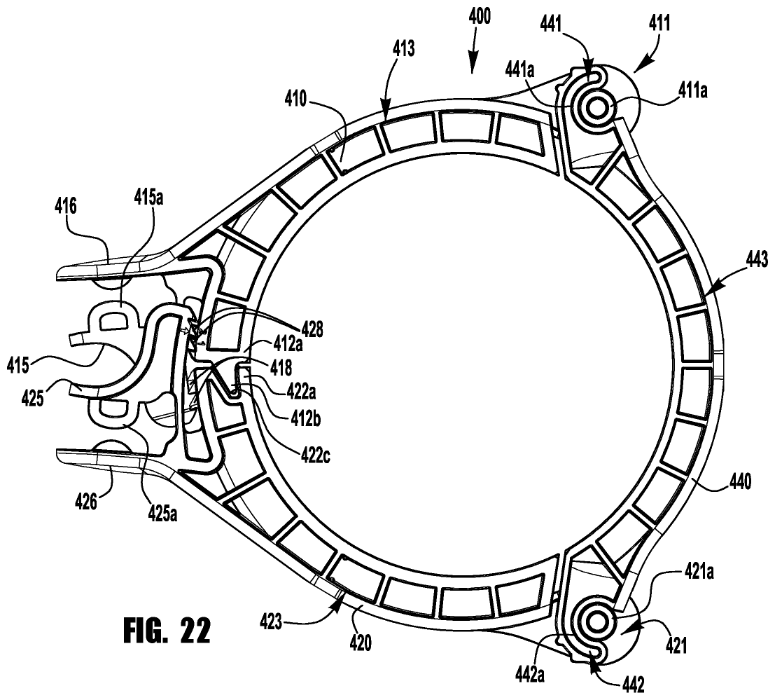

In still other embodiments, a clamp may utilize, as a hinge arrangement, a third or middle gland member hingedly connected between the hinge portions of the first and second gland members, which may, for example, allow for use of shorter arcuate channel segments in the gland members, which may provide for better dimensional controls of these features and improved manufacturability. One such exemplary three gland clamp 400 is shown in FIGS. 19-24 and described in greater detail below.

Between the hinge end portions 311, 321 and the locking end portions 312, 322, the gland members 310, 320 each define a generally semicircular or arcuate shaped clamping portion 313, 323 including an outer periphery 313a, 323a and an inner periphery 313b, 323b. Located along the inner periphery 313b, 323b is an arcuate channel or inner peripheral recess 314, 324 that is sized to receive the circular flanges of the conduit sections upon insertion of those flanges into the clamp 300. As shown, the exemplary inner peripheral recesses 314, 324 combine to form a substantially full (e.g., 350 to 360 degree) periphery around the circular flanges when the conduit sections are located in the clamp 300 and the clamp is in the closed or clamping condition. The inner peripheral recesses 314, 324 may be provided with any suitable shape or contour. In the illustrated embodiment, the arcuate inner peripheral recesses 314, 324 are configured to wedge the circular flanges towards one another and towards the gasket to form a sealed relationship, similar to the arrangement shown in FIG. 7. In other embodiments, the interior surface of the arcuate inner peripheral recesses may include toothed, notched, or hollow structures, for example, so as to save material when molding the first and second gland members 310, 320.

The exemplary gland members 310, 320 further include handle portions 316, 326 projecting radially outward from the locking portions 312, 322 of the gland members, providing user graspable or grippable portions for user movement of the gland members between the open and closed conditions.

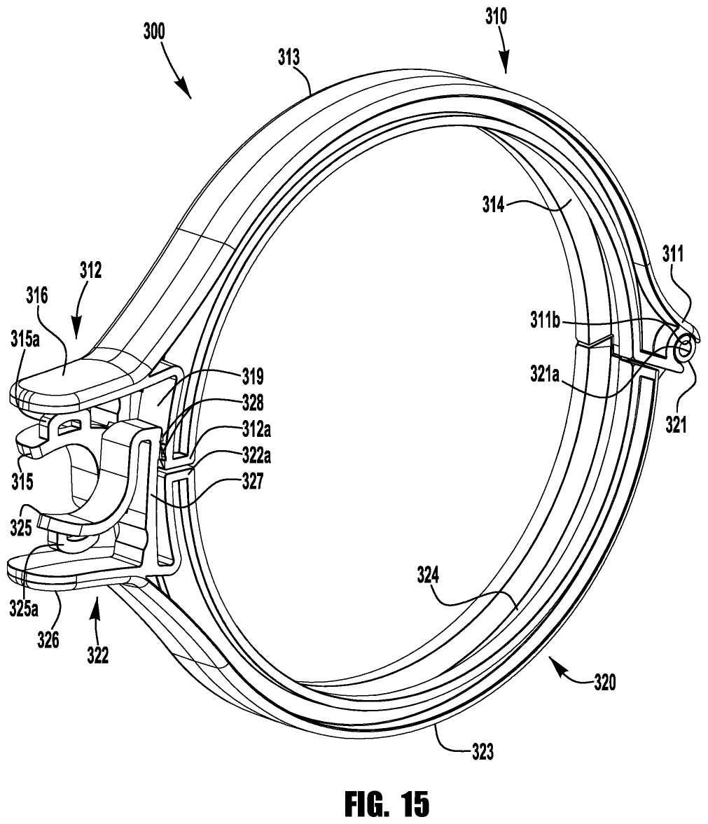

To securely close the clamp 300 on the conduit sections, a user may grasp and squeeze the first and second handles 316, 326 towards one another to pivot the first and second gland members 310, 320 at the hinge arrangement 301 until the end wall portions 312a, 322a of the locking portions 312, 322 are brought into abutment (e.g., into contact or close facing alignment) in the closed condition as shown in FIGS. 15-17. Once in the closed position, the exemplary first and second handles 316, 326 extend in the same general direction, such that the first and second handles may be generally parallel to one another in the closed condition of the clamp 300. However, it will be appreciated that the specific positioning and angling of the first and second handles may vary in other embodiments.

In order to reliably retain the clamp 300 in the closed condition, the gland members 310, 320 each include at least one interlock feature (e.g., detent) 318, 328 disposed on a flexible wall portion 317, 327 of the gland locking end portion 312, 322, for releasable interlocking engagement with the locking portion of the other gland member when the clamp is in the closed or clamping condition. In various embodiments, the at least one detent may be configured to interlock with a variety of structures on the locking end portion of the other gland member. In the illustrated embodiment of FIGS. 14-18, the at least one detent 318 of the first gland member 310 is positioned (e.g., with the flexible wall portion 317 extending from a base portion of the first handle 316) for interlocking engagement with a detent bearing interlocking wall portion 329 of the second gland member 320. Likewise, the at least one detent 328 of the second gland member 320 is positioned (e.g., with the flexible wall portion 327 extending from a base portion of the second handle 326) for interlocking engagement with a detent bearing interlocking wall portion 319 of the first gland member 310.

Extending from each of the flexible wall portions 317, 327 are user depressible lever portions 315, 325 for flexing disengagement of the at least one detent 318, 328 from the detent bearing interlocking wall portion 329, 319 of the other gland member 320, 310 to permit movement of the first and second gland members to the open position. In some embodiments, simultaneous user depression of both of the lever portions 315, 325 may be required for disengagement of the locking portions 312, 322 and movement of the clamp 300 to the open condition, providing for more secure or robust retention of the clamp 300 on the conduit sections. In the illustrated embodiment, the lever portions 315, 325 are contoured to extend toward the clamping portion 313, 323 of the corresponding gland member 310, 320 (e.g., parallel to the flexible wall portion 317, 327) and radially outward, such that a squeezing force applied to the lever portion 315, 325 and corresponding handle 316, 326 flexes the flexible wall portion 317, 327 radially outward for disengagement of the detent(s) 318, 328 from the corresponding interlocking wall portions 319, 329. In other embodiments, the lever portion may be provided in a different orientation (e.g., coplanar with the flexible wall portion).

In the illustrated embodiment, each of the flexible wall portions 317, 327 includes two detents 318, 328, for example to provide multiple attachment points for more robust interlocking engagement, or to provide multiple ratcheting closed conditions. In other embodiments, fewer or more detents may be provided on either or both of the flexible wall portions.

Each of the detents 318, 328 may protrude radially as stepped ridges or teeth from the corresponding flexible wall portion 317, 327. More specifically, each of the detents 318, 328 includes an angled front surface facing towards the distal end of the flexible wall and a transverse rear surface facing towards the proximal end of the flexible wall. These front and rear surfaces enable snap-over or ratcheting engagement of the first and second gland detents 318, 328 with the corresponding interlocking wall portions, which may include similarly shaped detent portions 319a, 329a. It will be understood that the particular angling of the angled front surface and the transverse rear surface may be modified in other embodiments while still enabling interlocking engagement.

The lever portions 315, 325 may include additional elements to help ensure that the lever portions are not accidentally depressed before the clamp 300 is supposed to be re-opened. To this end, the lever portions 315, 325 may be provided with tie-receiving loops 315a, 325a (e.g., U-shaped structures, as shown) extending towards each other. When a zip tie or other such tie element is wrapped through the first and second tie-receiving loops 315a, 325a and tightened, the lever portions 315, 325 are held in tension against user depression and the resulting flexing movement of the flexible wall portions 317, 327, thereby preventing unintended or undesirable disengagement of the detents 318, 329a, 328, 329a and release of the clamp 300. As a result, the tie-receiving loops 315a, 325a may be employed to further enhance the retention of the clamp 300 in the closed position until it is desired to re-open the clamp 300, at which point the zip tie can be cut off and then the lever portions 315, 325 depressed as detailed above. The specific location and shape of the first and second tie-receiving loops may be modified in other embodiments without departing from the functionality or scope of the clamp 300.

The exemplary gland members 310, 320 are each integrally molded or otherwise formed to be a unitary piece of plastic material, such as, for example, nylon. In such an embodiment, the hinge portion 311, 321, the locking portion 312, 322, the clamping portion 313, 323, the handle 316, 326, the flexible wall portion 317, 327, and the lever portion 315, 325 of each gland 310, 320 are one unitary piece of material with enough flexibility to enable the flexing or pivoting movement of the flexible wall portion 317, 327 with respect to the locking portion 312, 322, but with sufficient rigidity to hold the circular flanges of the conduit sections in reliable sealed engagement when the clamp 300 is in the closed position. The specific materials and method of manufacturing for the first and second gland members 310, 320 may be modified to suit the needs and preferences of end users.

Additionally, the exemplary gland members 310, 320 may be molded or otherwise formed as identical or substantially identical gland components, for example, to allow for use of a single mold to form both gland members, and to allow for storage of a single type of gland member for production of the clamp 300. As discussed above, when the gland members are oriented for assembly (with the hinge portions 311, 321 and locking portions 312, 122 facing each other), the pin portion 311a of the first gland member 310 aligns with and is received in the socket portion 321b of the second gland member 320, and the pin portion 321a of the second gland member aligns with and is received in the socket portion 311b of the first gland member. Likewise, the detents 318, 328 of each gland member 310, 320 laterally and radially align with the detents 329a, 319a of the interlocking wall portion 329, 319 of the other gland member, for flexing and ratcheting interlocking engagement of the detents 318, 329a, 328, 319a when the gland members are pivoted to the clamp's closed condition.

When in use, a user can move the clamp 300 to the closed position by grasping the handle portions 316, 326 and drawing (e.g., pushing, pulling, squeezing) the handle portions towards one another. This movement of the handle portions 316, 326 causes relative movement of locking end portions 312, 322 of the first and second gland members 310, 320 towards one another as a result of the pivotal coupling at the hinge arrangement 301. During this pivotal movement, the first gland member flexible wall detents 318 begin snapping over the second gland member interlocking wall detents 329a, and the second gland member flexible wall detents 328 begin snapping over the first gland member interlocking wall detents 319a. To this end, as the first and second gland members 310, 320 move towards each other from the open position of FIG. 14 to the closed, latched position of FIGS. 15-17, the interlocking detents 318, 329a and 328, 319a may slide along and past each other until the abutting engagement between the end wall portions 312a, 322a of the locking portions 312, 322, or until sufficient clamping force is applied to the flange ends and gasket (which may, but need not, correspond with contacting abutment of the end wall portions). This clamped condition may also correspond to when the most proximal of the flexible wall detents 318, 328 mesh with the most proximal of the interlocking wall detents 329a, 319a. Due to the close abutment or contact between the end wall portions 312a, 322a in this closed condition, a substantially full (e.g., 350 to 360 degree) peripheral engagement of the circular flanges may be provided. After the first and second handles 316, 326 are squeezed together to make the end wall portions 312a, 322a of the first and second gland members 110, 120 abut in the closed condition, the flexible wall detents 318, 128 may be fully meshed with the interlocking wall detents 329a, 319a so that the corresponding transverse rear surfaces of the toothed detents engage to retain the clamp 300 in the closed condition.

To loosen or disassemble the clamp 300 from the conduit sections (e.g., to separate the conduit sections, or to replace one or more of the conduit sections and the gasket), the lever portions 315, 325 are depressed for flexing disengagement of the flexible wall detent(s) 318, 328 from the interlocking wall detent(s) 329a, 319a to permit movement of the first and second gland members 310, 320 toward the open position.

FIGS. 19 through 24 illustrate another exemplary embodiment of a clamp 400 used to join together two conduit sections, such as, for example, flanged sanitary fittings. The exemplary clamp 400 includes first and second gland members 410, 420 having joint or hinge portions 411, 421 pivotably connected by a third, middle gland member 440 (described in greater detail below), releasably engageable locking portions 412, 422, and medial, arcuate clamping portions 413, 423 configured to form (with the third gland member 440) a circular closure around a circular structure (e.g., flanged ends of sanitary fittings) when the locking portions 412, 422 are secured together in a closed or clamping condition of the clamp 400, for example, to provide substantially uniform sealing pressure around the entire circular structure. In other embodiments, the clamp may be used to provide clamping engagement with other fittings or components, including, for example, components having a non-circular shape. Advantageously, the clamp 400 may be able to be re-opened and reused with different sets of conduit sections, should that be desirable for the end user. In the illustrated embodiment, the first and second gland members 410, 420 of the clamp 400 each include a user manipulable (e.g., hand graspable, tool engageable) latch release arm or lever 415, 425 that may enable simplified disengagement of the gland member locking portions 412, 422, and/or more robust interlocking engagement of the locking portions of the gland members. The clamp 400 may be configured such that extra tools and/or specialized equipment are not required to operate the clamp between open and closed positions, and the clamp and conduit sections are not damaged or destroyed by the process of moving the clamp back to the open position. In some embodiments, the clamp 400 may be functional as a single-use clamp or as a reusable clamp. Further advantages are evidenced in the detailed discussion of this and other embodiments herein.

With particular reference to FIGS. 19 and 20-22, the clamp 400 is shown in an open position and in a closed position, respectively. In this embodiment, the first and second gland members 410, 420 of the clamp 400 are generally arcuate between a first end hinge portion 411, 421 and a second end locking portion 412, 422 opposite the first end. The corresponding hinge portions 411, 421 of the first and second gland members 410, 420 may be detachably joined, for example, by a hinge arrangement 401 that includes the third gland member 440. While many suitable hinge arrangement structures may be used for pivotably connecting the hinge portions 411, 421 of the first and second gland members 410, 420, in the illustrated embodiment, each hinge portion 411, 421 includes laterally extending pin portions 411a, 421a received in corresponding arcuate receptacles or socket portions 441a, 442a on end portions 441, 442 of the third gland member 440. In other embodiments (not shown), the clamp may utilize other hinge arrangements, including, for example, first and second gland members having laterally opposed arcuate receptacles receiving laterally extending pin portions of a third middle gland, or apertured hasp and pivot pin hinge arrangements, for example, similar to the apertured hasp and pivot pin hinge arrangement 201 of the clamp 200 of FIGS. 8-13, described in greater detail above.

Between their end portions 411, 412, 421, 422, 441, 442, the first, second and third gland members 410, 420, 440 each define an arcuate shaped clamping portion 413, 423, 443 including an outer periphery 413a, 423a, 443a and an inner periphery 413b, 423b, 443b. Located along the inner periphery 413b, 423b, 443b is an arcuate channel or inner peripheral recess 414, 424, 444 that is sized to receive the circular flanges of the conduit sections upon insertion of those flanges into the clamp 400. As shown, the exemplary inner peripheral recesses 414, 424, 444 combine to form a substantially full (e.g., 350 to 360 degree) peripheral channel around the circular flanges when the conduit sections are located in the clamp 400 and the clamp is in the closed or clamping condition. In the illustrated embodiment, the inner peripheral recesses 414, 424, 444 of each of the first, second, and third gland members 410, 420, 440 may each form approximately one third (e.g., about 115 to 120 degrees) of the full peripheral channel. In other embodiments, the inner peripheral recess 444 of the third gland member 440 may form more or less than one third of the full peripheral channel, with the inner peripheral recesses 414, 424 of the first and second gland members 410, 420 combining to account for the rest of the full peripheral channel.

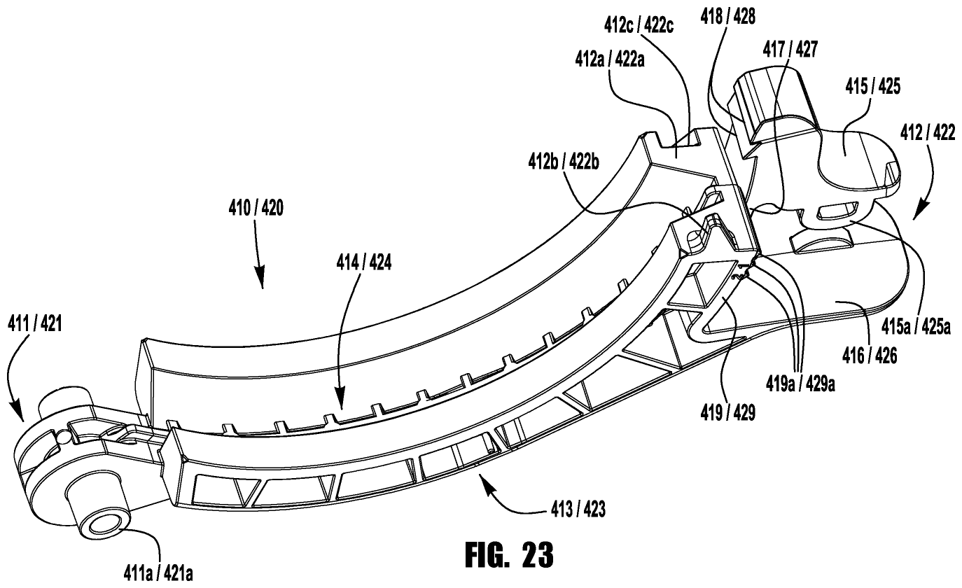

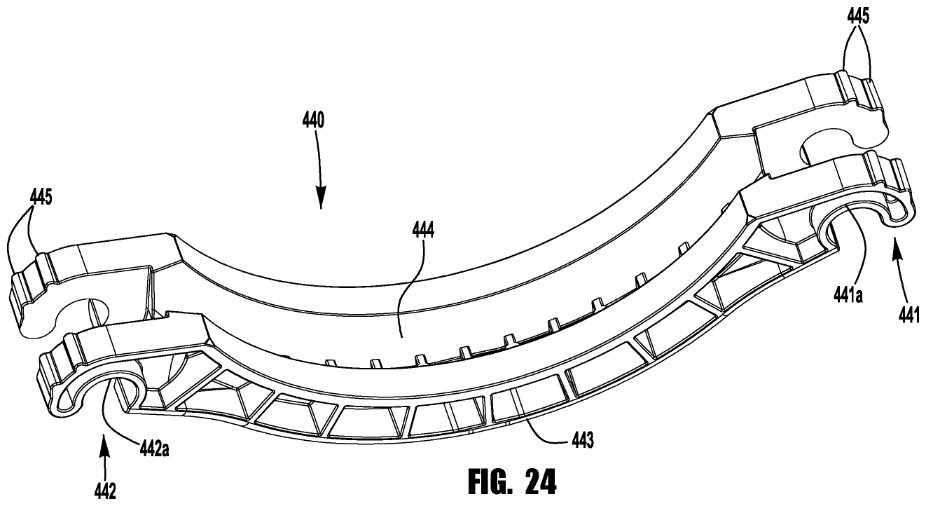

The inner peripheral recesses 414, 424, 444 may be provided with any suitable shape or contour. In the illustrated embodiment, the arcuate inner peripheral recesses 414, 424, 444 are configured to wedge the circular flanges towards one another and towards the gasket to form a sealed relationship, similar to the arrangement shown FIG. 7. In other embodiments, the interior surface of the arcuate inner peripheral recesses may include toothed, notched, or hollow structures (as evident in FIGS. 23 and 24), for example, so as to save material when molding the gland members 410, 420, 440.

The exemplary first and second gland members 410, 420 further include handle portions 416, 426 projecting radially outward from the locking portions 412, 422 of the gland members, providing user graspable or grippable portions for user movement of the gland members between the open and closed conditions.

The end portions 441, 442 of the third gland member 440 may include ribs or projections 445 that engage rear edges 413c, 423c of the first and second gland clamping portions 413, 423 to resist movement of the first and second glands 410, 420 toward the closed position, for example, to prevent loose pivoting movement of the gland members toward the closed position.

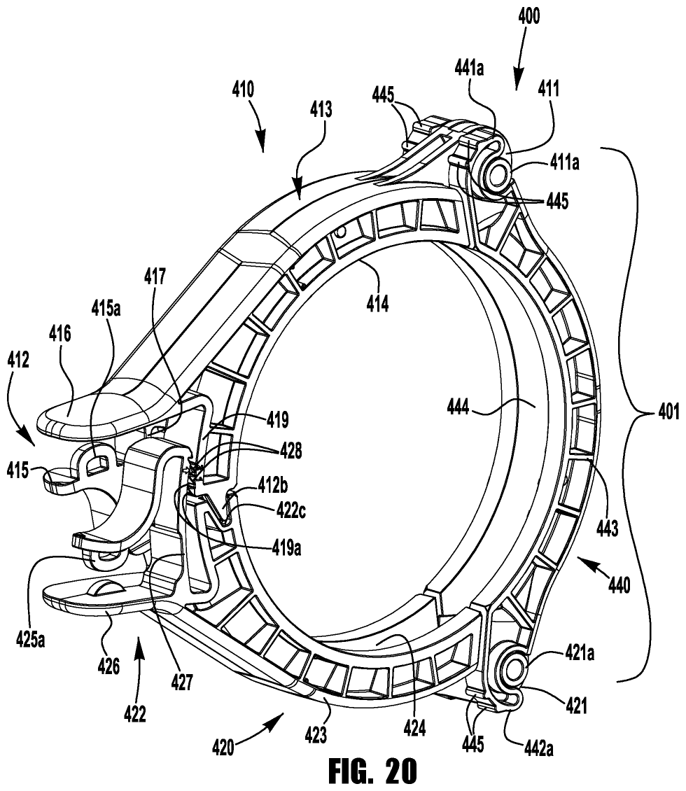

To securely close the clamp 400 on the conduit sections, a user may grasp and squeeze the first and second handles 416, 426 towards one another to pivot the first and second gland members 410, 420 at the hinge arrangement 401 until the end wall portions 412a, 422a of the locking portions 412, 422 are brought into abutment (e.g., into contact or close facing alignment) in the closed condition as shown in FIGS. 20-22. Once in the closed position, the exemplary first and second handles 416, 426 extend in the same general direction, such that the first and second handles may be generally parallel to one another in the closed condition of the clamp 400. However, it will be appreciated that the specific positioning and angling of the first and second handles may vary in other embodiments.

In order to reliably retain the clamp 400 in the closed condition, the first and second gland members 410, 420 may utilize a variety of releasable interlocking detent arrangements. In the illustrated embodiment, similar to the embodiment of FIGS. 14-18 (as described in greater detail above), the gland locking end portions 412, 422 each include at least one interlock feature (e.g., detent) 418, 428 disposed on a flexible wall portion 417, 427 for interlocking engagement with a detent bearing interlocking wall portion 429, 419 of the locking end portion 422, 412 of the other gland member 420, 410, with user depressible lever portions 415, 425 for flexing disengagement of the at least one detent 418, 428 from the detent bearing interlocking wall portions 429, 419. Also similar to the embodiment of FIGS. 14-18, the lever portions 415, 425 may include tie-receiving loops 415a, 425a to hold the lever portions in tension to prevent unintended or undesirable disengagement of the detents 418, 429a, 428, 429a until the securing tie is removed (e.g., cut) from the loops. In other embodiments (not shown), a three-piece clamp otherwise similar to the clamp 400 of FIGS. 19-24 may utilize other interlocking, releasing and securing arrangements, such as, for example, the interlocking and releasing arrangements of the clamps 100, 200 of FIGS. 2-7 and 8-13 as described herein.

The exemplary gland members 410, 420, 440 are each integrally molded or otherwise formed to be a unitary piece of plastic material, such as, for example, nylon. In such an embodiment, the hinge portion 411, 421, the locking portion 412, 422, the clamping portion 413, 423, the handle 416, 426, the flexible wall portion 417, 427, and the lever portion 415, 425 of the first and second glands 410, 420 are each one unitary piece of material with enough flexibility to enable the flexing or pivoting movement of the flexible wall portion 417, 427 with respect to the locking portion 412, 422, but with sufficient rigidity to hold the circular flanges of the conduit sections in reliable sealed engagement when the clamp 400 is in the closed position. The end portions 441, 442 and the clamping portion 443 of the third gland of the third gland are likewise one unitary piece of material. The specific materials and method of manufacturing for the gland members 410, 420 may be modified to suit the needs and preferences of end users.

Additionally, the exemplary first and second gland members 410, 420 may be molded or otherwise formed as identical or substantially identical gland components, for example, to allow for use of a single mold to form both of the first and second gland members, and to allow for storage of a single type of end gland member for production of the clamp 400, in combination with the different third gland member 440. As discussed above, when the gland members are oriented for assembly (with the hinge portions 411, 421 facing the end portions 441, 442 of the third gland member 440), the pin portions 411a of the first gland member 410 align with and are received in the socket portions 441a of the third gland member's first end portion 441, and the pin portions 421a of the second gland member 420 align with and are received in the socket portions 442a of the third gland member's second end portion 442. Likewise, the detents 418, 428 of the first and second gland members 410, 420 laterally and radially align with the detents 429a, 419a of the interlocking wall portion 429, 419 of the other gland member, for flexing and ratcheting interlocking engagement of the detents 418, 3429a, 428, 419a when the gland members are pivoted to the clamp's closed condition.

According to another exemplary aspect of the present disclosure, the locking portions of first and second gland members of a clamp may include reinforcing portions that engage with each other when the locking portions are brought into abutment in the clamp's clamping position, for example, to facilitate alignment of interlocking features (e.g., toothed detents) and/or to reinforce the locking portions against damage or accidental disengagement, due to dropping or other such impact. For example, a projection extending longitudinally from the locking portion of one of the first and second gland members may be slidably received into a longitudinally extending cavity in the locking portion of the other of the first and second gland members when the first and second gland members are moved to the clamping position. Such an arrangement may secure the first locking portion against radial movement with respect to the second locking portion, for example, to maintain interlocking engagement of radially engageable interlocking features (e.g., toothed detents). In exemplary embodiments using identical or substantially identical first and second gland members, each of the first and second gland members may include a projection extending longitudinally from the locking portion that is slidably received into a longitudinally extending cavity in the locking portion of the other of the first and second gland members.

In the exemplary clamp of FIGS. 19-24, the locking portions 412, 422 of each gland member 410, 420 includes longitudinally extending, mating projection (e.g., tab) and cavity (e.g., notch) portions 412b, 422b, 412c, 422c engageable with the projection and cavity portions of the other gland member, for example, to facilitate adequate radial alignment of the locking portions in the clamp's closed condition. As shown, the tabs 412b, 422b and notches 412c, 422c may be longitudinally tapered to facilitate engagement and alignment of the tabs and notches as the gland members are pivoted to the clamping position. Similar reinforcing portions may be provided in the other clamp embodiments shown and described herein.

When in use, a user can move the clamp 400 to the closed position by grasping the handle portions 416, 426 and drawing (e.g., pushing, pulling, squeezing) the handle portions towards one another. This movement of the handle portions 416, 426 causes relative movement of locking end portions 312, 322 of the first and second gland members 410, 420 towards one another as a result of the pivotal coupling at the hinge arrangement 401. During this pivotal movement, the reinforcing projections 412b, 422b of each locking portion 412, 422 are received in the reinforcing cavities 422c, 412c of the other locking portion, and the first gland member flexible wall detents 418 begin snapping over the second gland member interlocking wall detents 429a, and the second gland member flexible wall detents 428 begin snapping over the first gland member interlocking wall detents 419a. To this end, as the first and second gland members 410, 420 move towards each other from the open position of FIG. 19 to the closed, latched position of FIGS. 20-22, the interlocking detents 418, 429a and 428, 419a may slide along and past each other until the abutting engagement between the end wall portions 412a, 422a of the locking portions 412, 422, or until sufficient clamping force is applied to the flange ends and gasket (which may, but need not, correspond with contacting abutment of the end wall portions). This clamped condition may also correspond to when the most proximal of the flexible wall detents 418, 428 mesh with the most proximal of the interlocking wall detents 429a, 419a. Due to the close abutment or contact between the end wall portions 412a, 422a in this closed condition, a substantially full (e.g., 350 to 360 degree) peripheral engagement of the circular flanges may be provided. After the first and second handles 416, 426 are squeezed together to make the end wall portions 412a, 422a of the first and second gland members 410, 420 abut in the closed condition, the flexible wall detents 418, 428 may be fully meshed with the interlocking wall detents 429a, 419a so that the corresponding transverse rear surfaces of the toothed detents engage to retain the clamp 400 in the closed condition.

To loosen or disassemble the clamp 400 from the conduit sections (e.g., to separate the conduit sections, or to replace one or more of the conduit sections and the gasket), the lever portions 415, 425 are depressed for flexing disengagement of the flexible wall detent(s) 418, 428 from the interlocking wall detent(s) 429a, 419a to permit movement of the first and second gland members 410, 420 toward the open position.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

We claim:

1. A clamp comprising:
a first gland member comprising a first joint portion, a first locking portion, and a first clamping portion disposed between the first joint portion and the first locking portion;
a second gland member comprising a second joint portion, a second locking portion, and a second clamping portion disposed between the second joint portion and the second locking portion;
wherein the first and second joint portions are connected for movement of the first and second gland members between an open position and at least one clamping position;
wherein the first locking portion is configured to interlock with the second locking portion to secure the first and second gland members in the at least one clamping position; and
wherein the first and second locking portions further include corresponding first and second user manipulable release portions, independently operable for disengagement of the corresponding one of the first and second locking portions from the other of the first and second locking portions to permit movement of the first and second gland members to the open position.

2. The clamp of claim 1, wherein the first and second joint portions, the first and second locking portions, and the first and second clamping portions of the first and second gland members are substantially identical.

3. The clamp of claim 1, wherein the first and second gland members are substantially identical.

4. The clamp of claim 1, wherein the first and second clamping portions define first and second inner peripheral recesses for receiving edge portions of outer radial flanges when the clamp is assembled with the outer radial flanges.

5. The clamp of claim 4, wherein the first and second inner peripheral recesses are shaped to accommodate circular outer radial flanges.

6. The clamp of claim 1, wherein the first joint portion comprises a first hinge portion and the second joint portion comprises a second hinge portion, the first and second hinge portions being connected for pivotable movement of the first and second gland members between the open position and the at least one clamping position.

7.-9. (canceled)

10. The clamp of claim 6, further comprising a third gland member having a first end portion hingedly connected to the first hinge portion a second end portion hingedly connected to the second hinge portion.

11. The clamp of claim 10, wherein the third gland member includes a third clamping portion disposed between the first and second end portions.

12. The clamp of claim 11, wherein the first, second, and third clamping portions each form approximately one third of a full peripheral channel.

13. The clamp of claim 10, wherein the first and second end portions of the third gland member each include one of laterally opposed arcuate receptacles and laterally extending pin portions, and the first and second hinge portions each include the other of the laterally opposed arcuate receptacles and laterally extending pin portions, wherein the laterally extending pin portions are received in the laterally opposed arcuate receptacles for hinged connection therebetween.

14. The clamp of claim 1, wherein the first and second locking portions each include a flexible wall portion carrying at least one detent configured to interlock with the other of the first and second locking portions to secure the first and second gland members in the at least one clamping position, wherein each of the first and second release portions is operable for movement of the corresponding flexible wall portion, for flexing disengagement of the at least one detent from the locking portion of the other of the first and second gland members to permit movement of the first and second gland members to the open position.

15. (canceled)

16. The clamp of claim 14, wherein the at least one detent comprises a ratcheting detent permitting ratcheting advancement of the first and second gland members toward closer abutment of the first and second locking portions without user actuation of the corresponding one of the first and second release portions.

17.-19. (canceled)

20. The clamp of claim 14, wherein the at least one detent of each of the first and second gland members is configured to interlock with a rigid wall portion of the locking portion of the other of the first and second gland members.

21. The clamp of claim 14, wherein the at least one detent of each of the first and second gland members projects radially inward.

22.-23. (canceled)

24. The clamp of claim 14, wherein the first and second release portions each comprise a lever portion extending from the corresponding flexible wall portion.

25. The clamp of claim 24, wherein the lever portion of each of the first and second gland members projects radially outward.

26.-29. (canceled)

30. The clamp of claim 1, wherein when the first and second gland members are moved to the at least one clamping position, a longitudinally extending projection of one of the first and second locking portions is slidingly received into a longitudinally extending cavity of the other of the first and second locking portions to secure the first locking portion against radial movement with respect to the second locking portion.

31.-32. (canceled)

33. The clamp of claim 1, wherein user operation of both of the first and second user manipulable release portions is required to enable movement of the first and second gland members from the at least one clamping position to the open position.

34. A clamp comprising:
a first gland member comprising a first hinge portion, a first locking portion, and a first clamping portion disposed between the first hinge portion and the first locking portion;
a second gland member comprising a second hinge portion, a second locking portion, and a second clamping portion disposed between the second hinge portion and the second locking portion;
wherein the first and second hinge portions are connected for pivotable movement of the first and second gland members between an open position and at least one clamping position, with the first hinge portion including a first pin portion disposed on a first lateral side of the clamp and a first socket portion disposed on a second lateral side of the clamp, and the second hinge portion including a second socket portion disposed on the first lateral side of the clamp and receiving the first pin portion, and a second pin portion disposed on the second lateral side of the claim and received in the first socket portion; and
wherein the locking portion of each of the first and second gland members is configured to interlock with the locking portion of the other of the first and second gland members to secure the first and second gland members in the at least one clamping position.

35.-43. (canceled)

44. A clamp comprising:
a first gland member comprising a first joint portion, a first locking portion and a first clamping portion extending longitudinally between the first joint portion and the first locking portion;
a second gland member comprising a second joint portion, a second locking portion and a second clamping portion extending longitudinally between the second joint portion and the second locking portion;
wherein the first and second joint portions are connected for movement of the first and second gland members between an open position and at least one clamping position;
wherein when the first and second gland members are moved to the at least one clamping position:
an interlock feature of the first locking portion interlocks with an interlock feature of the second locking portion to secure the first and second gland members in the at least one clamping position; and
a longitudinally extending projection of the first locking portion is slidingly received into a longitudinally extending cavity of the second locking portion to secure the first locking portion against radial movement with respect to the second locking portion.

45.-58. (canceled)
